(19) United States
(12) Patent Application Publication
(10) Pub. No.: US 2026/0265462 A1
(43) Pub. Date: Sep. 10, 2026

(54) SILICONE - POLYETHER COPOLYMER FOR USE IN FOAM CONTROL FORMULATIONS

(71) Applicant: Dow Silicones Corporation, Midland, MI (US)

(72) Inventors: Jacqueline Lhostis, Silly (BE); Eric Joffre, Midland, MI (US); Sudhakar Balijepalli, Midland, MI (US)

(21) Appl. No.: 19/472,112

(22) PCT Filed: Jun. 12, 2024
(86) PCT No.: PCT/US2024/033481

§ 371 Date: Oct. 3, 2025

Related U.S. Application Data
(60) Provisional application No. 63/525,183, filed on Jul. 6, 2023.

(51) Int. Cl. C08G 77/18; C11D 1/83; C11D 3/20; C11D 3/30; C11D 3/37

(52) U.S. Cl. CPC C08G 77/18; C11D 1/83; C11D 3/2044; C11D 3/30; C11D 3/3738; C11D 2111/12

(57) ABSTRACT

A silicone-polyether copolymer and methods for its preparation and use are disclosed. The silicone-polyether copolymer is useful as a foam control agent in a laundry detergent composition.

### CROSS REFERENCE TO RELATED APPLICATIONS

This application claims the benefit of U.S. Provisional Patent Application Ser. No. 63/525,183 filed on Jul. 6, 2023, under 35 U.S.C. § 119 (e). U.S. Provisional Patent Application Ser. No. 63/525,183 is hereby incorporated by reference.

### FIELD

This invention relates to a silicone-polyether copolymer and methods for its preparation and use. Said copolymer may be used in foam control applications.

### INTRODUCTION

Silicone foam control formulations are known for use in a variety of applications, such as pulp and paper, chemical, textile (e.g., dyeing and/or laundering), fermentation and sugar beet processing, water treatment, and metal working along with use in paints, latexes, cement, fertilizers, soaps and detergents. Such foam control formulations typically include multiple constituents, including a silicone “foam control agent”, which may also be referred to as an antifoam, a defoamer, a suds suppressor or a foam inhibitor. A foam control agent is a material that when added in low concentration, reduces or controls the amount of foaming in an otherwise foaming liquid. Polyorganosiloxanes, and more specifically, polydimethylsiloxanes (PDMS) are the most common foam control agents. Silicone foam control compositions also commonly include hydrophobic inorganic fillers (e.g., silica and/or zeolites) and surfactants that promote the dispersion of the formulation and provide stability when the formulation is provided as an emulsion.

U.S. Pat. No. 6,521,586 discloses silicone-based foam control agents, particularly for use in aqueous compositions, preferably detergent compositions. The detergent industry is constantly going through an evolution where, due to environmental concern, energy conservation efforts, machine design changes, water conservation and changing laundering habits there is a move towards the use of detergent compositions which will perform at higher efficiency than hitherto. There is a need to control foam from e.g., increased surfactant levels in the detergent compositions, use of surfactants which have a higher foam profile than traditional surfactants, changing laundering conditions. Since silicone foam control agents do not directly contribute to the cleaning power of a detergent composition it is desirable to keep the addition level of such foam control agents to a minimum. There has, therefore, arisen a need to develop improved foam control agents for incorporation in detergent compositions. There is also a desire for foam control agents that can be used in transparent liquid laundry detergents, such that the foam control agent does not affect, or only minimally affects, transparency of said detergents.

### SUMMARY

A silicone-polyether copolymer (SPE copolymer) is provided. A method for synthesizing the SPE copolymer is also provided. The SPE copolymer is useful as a foam control agent.

### DETAILED DESCRIPTION

The method for synthesizing the SPE copolymer, introduced above, comprises: 1) combining, under conditions to effect hydrosilylation reaction, starting materials comprising A) an alkenyloxy-, aryl-terminated glycol ether, B) a polyorganohydrogensiloxane, and C) a hydrosilylation reaction catalyst. The starting materials may optionally further comprise D) an alkenyl-functional aromatic compound that differs from A) the alkenyloxy-, aryl-terminated glycol ether, E) a dialkenyl-terminated siloxane oligomer, F) a solvent, or a combination of two or more of D), E), and F).

Step 1) may be performed by any convenient means in any convenient equipment. For example, when the method is performed in a batch mode, a reactor with heating and cooling means (such as a jacket containing water or other heat transfer fluid) and mixing means (such as baffles and/or an agitator) may be used. One or more of the starting materials may be combined in the reactor, and thereafter the remaining starting materials may be added, either all at once, or metering into the reactor continuously or intermittently in aliquots. For example, starting materials with alkenyl groups, such as A) the alkenyloxy-, aryl-terminated glycol ether and when used D) the alkenyl-functional aromatic compound and/or E) the dialkenyl-terminated siloxane oligomer may be combined with B) the polyorganohydrogensiloxane, and thereafter all or a portion of C) the hydrosilylation reaction catalyst may be added. Additional portions of alkenyl-functional starting materials and C) hydrosilylation reaction catalyst may be added one or more times until the silicon bonded hydrogen atoms of B) the polyorganohydrogensiloxane have reacted with alkenyl groups.

Alternatively, starting materials with alkenyl groups, i.e., A) the alkenyloxy-, aryl-terminated glycol ether and, when used, D) the alkenyl-functional aromatic compound and/or E) the dialkenyl-terminated siloxane oligomer, may be combined with all or a portion of C) the hydrosilylation reaction catalyst in the reactor. Thereafter, B) the polyorganohydrogensiloxane may be added continuously or intermittently with heating or cooling to control the reaction rate. Without wishing to be bound by theory, when the hydrosilylation reaction is performed on a commercial scale, it may be desirable to separate B) the polyorganohydrogensiloxane and C) the hydrosilylation reaction catalyst until just before reaction with the alkenyl-functional starting materials for safety reasons.

The hydrosilylation reaction in step 1) may be performed at a temperature of 50° C. to 150° C. for a time sufficient to react all of the silicon bonded hydrogen atoms of starting material B) with an alkenyl group of starting material A) (and when present, starting material D) and/or starting material E)).

The method may optionally further comprise one or more additional steps. For example, one or more of the starting materials may optionally be dissolved in F) the solvent before or during step 1). For example, C) the hydrosilylation reaction catalyst may be dissolved in F) the solvent before combining with the other starting materials used in step 1). The method may optionally further comprise step 2) recovering the SPE copolymer. Recovering may be performed by any convenient means, such as one or more of:
color removal (e.g., via treating the reaction product comprising the SPE copolymer prepared in step 1) with an adsorbent such as activated carbon, either batchwise or continuously by passing the reaction product through a packed bed of activated carbon);
filtration (e.g., to remove activated carbon in the batchwise process and/or other particulate); and/or
stripping and/or distillation (e.g., to remove solvent, when used, a side product of the hydrosilylation reaction, if any, such as an isomerization product, and/or unreacted starting materials, e.g., when an excess of a starting material, described below, such as A) the alkenyloxy-, aryl-terminated glycol ether).

Starting material A), the alkenyloxy-, aryl-terminated glycol ether has general formula A1):

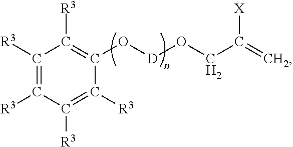

where X is H or methyl, D has empirical formula —C₂H₄— or —C₃H₆—, and subscript n is 1, 2, or 3. Alternatively, X may be methyl. Alternatively, D may have a formula selected from —CH₂—CH₂— or —CH₂—CH(CH₃)—. Alternatively, subscript n may be 1 or 2; and alternatively, subscript n may be 1. Alternatively, when X is H, and D is —C₂H₄—, then subscript n may be 2 or 3. Alternatively, A) the alkenyloxy-, aryl-terminated glycol ether may have general formula A2) when each R³ is H:

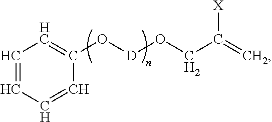

where X, D, and subscript n are as described and exemplified above. Examples of alkenyloxy-, aryl-terminated glycol ethers are shown below in Table A.

TABLE A
Exemplary Alkenyloxy-, Aryl- Terminated Glycol Ethers
Name and Formula
(2-(allyloxy)ethoxy)benzene of formula

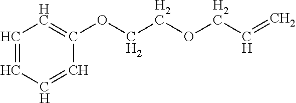

(C₆H₅—O—CH₂—CH₂—O—CH₂—CH═CH₂)
(2-(allyloxy)propoxy)benzene of formula

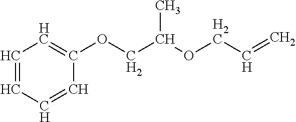

(C₆H₅—O—CH₂—CH(CH₃)—O—CH₂—CH═CH₂)
(2-((2-methylallyl)oxy)ethoxy)benzene of formula

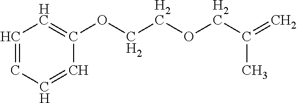

(C₆H₅—O—CH₂—CH₂—O—CH₂—C(CH₃)═CH₂)
(2-((2-methylallyl)oxy)propoxy)benzene of formula

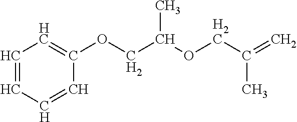

(C₆H₅—O—CH₂—CH(CH₃)—O—CH₂—C(CH₃)═CH₂)
(2-(2-(allyloxy)ethoxy)ethoxy)benzene of formula

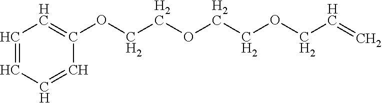 [SMILES: C=CCOCCOCCOc1ccccc1]

(C₆H₅—O—CH₂—CH₂—O—CH₂—CH₂—O—CH₂—CH═CH₂)
(2-(2-(allyloxy)propoxy)propoxy)benzene of formula

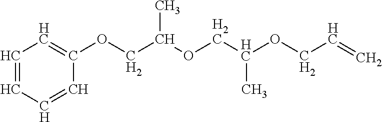 [SMILES: C=CCOC(C)COC(C)COc1ccccc1]

(C₆H₅—O—CH₂—CH(CH₃)—O—CH₂—CH(CH₃)—O—CH₂—CH═CH₂)
(2-(2-((2-methylallyl)oxy)ethoxy)ethoxy)benzene of formula

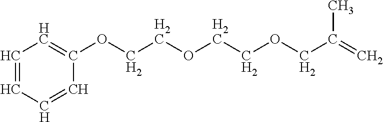 [SMILES: C=C(C)COCCOCCOc1ccccc1]

(C₆H₅—O—CH₂—CH₂—O—CH₂—CH₂—O—CH₂—CH═CH₂)
(2-(2-((2-methylallyl)oxy)propoxy)propoxy)benzene of formula

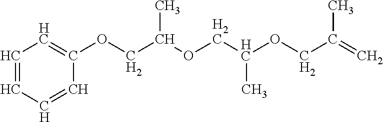 [SMILES: C=C(C)COC(C)COC(C)COc1ccccc1]

(C₆H₅—O—CH₂—CH(CH₃)—O—CH₂—CH(CH₃)—O—CH₂—CH═CH₂)

Alternatively, the alkenyloxy-, aryl-terminated glycol ether may be selected from the group consisting of: (2-(allyloxy) propoxy)benzene; (2-(2-(allyloxy) ethoxy) ethoxy)benzene; (2-(2-(allyloxy) propoxy) propoxy)benzene; (2-((2-methylallyl)oxy) ethoxy)benzene; (2-((2-methylallyl)oxy) ethoxy)benzene; (2-(2-((2-methylallyl)oxy) ethoxy) ethoxy)benzene; and (2-(2-((2-methylallyl)oxy) propoxy) propoxy)benzene. Alternatively, the alkenyloxy-, aryl-terminated glycol ether may be selected from the group consisting of: (2-(allyloxy) ethoxy)benzene; (2-(allyloxy) propoxy)benzene; (2-((2-methylallyl)oxy) ethoxy)benzene; and (2-((2-methylallyl)oxy) propoxy)benzene. Alternatively, the alkenyloxy-, aryl-terminated glycol ether may be selected from the group consisting of: (2-(allyloxy) propoxy)benzene; (2-((2-methylallyl)oxy) ethoxy)benzene; and (2-((2-methylallyl)oxy) propoxy)benzene.

The alkenyloxy-, aryl-terminated glycol ether may be prepared by a process comprising combining, under conditions to effect reaction, starting materials comprising an alkylene glycol aryl ether (such as an alkylene glycol phenyl ether), a catalyst (such as an organoammonium halide), and an alkenyl halide, such as allyl chloride. An aqueous base, such as aqueous sodium hydroxide may be added with mixing and optionally with heating. The resulting slurry may be separated using, e.g., a separatory funnel. The organic phase may be further purified, e.g., by water washing, separation, and stripping and/or distillation with heating and optionally reduced pressure to recover the alkenyloxy-, aryl-terminated glycol ether. For example, (2-(allyloxy) ethoxy)benzene (2-allyloxyethyl phenyl ether) can be prepared as described in U.S. Pat. No. 5,466,845 Example 2a), and alkenyloxy-, aryl-terminated glycol ethers can be prepared as described in the EXAMPLES, below, or as described in U.S. Pat. No. 5,466,845 by varying appropriate starting materials.

The following raw materials for preparing A) the alkenyloxy-, aryl-terminated glycol ether are available from The Dow Chemical Company of Midland, Michigan, USA. Ethylene glycol phenyl ether, which has formula C₆H₅—O—CH₂—CH₂—OH, is available as DOWANOL™ EPh Glycol Ether. Propylene glycol phenyl ether, which has formula C₆H₅—O—CH₂—CH(CH₃)—OH, is available as DOWANOL™ PPh Glycol Ether. Diethylene glycol phenyl ether, which has formula C₆H₅—O—CH₂CH₂—O—CH₂CH₂—OH is available as DOWANOL™ DiEPh Glycol Ether. Dipropylene glycol phenyl ether, which has formula C₆H₅—O—CH₂—CH(CH₃)—O—CH₂—CH(CH₃)—OH, is available as DOWANOL™ DiPPh Glycol Ether.

The amount of A) the alkenyloxy-, aryl-terminated glycol ether depends on various factors including the silicon bonded hydrogen content of B) the organohydrogensiloxane and whether one or both of D) the alkenyl-functional aromatic compound or E) the dialkenyl-terminated siloxane oligomer is present. However, the amount of A) the alkenyloxy-, aryl-terminated glycol ether is sufficient to provide at least one silicon bonded group of formula A1′), described above, per molecule of the SPE copolymer. Alternatively, the amount of A) the alkenyloxy-, aryl-terminated glycol ether may be sufficient to provide a molar ratio of alkenyloxy groups of starting material (A) to silicon bonded hydrogen atoms in starting material (B)>0/1 to 1.15, alternatively 1.1/1 to 1.15/1. Alternatively, the amount of starting material A) may be sufficient to react all of the silicon bonded hydrogen atoms in starting material B), such that the SPE copolymer does not contain unreacted silicon bonded hydrogen atoms. Alternatively, when starting materials D) and E) are present, the amounts of starting materials A), D) and E) combined, may be sufficient to react all of the silicon bonded hydrogen atoms in starting material B), such that the SPE copolymer does not contain unreacted silicon bonded hydrogen atoms.

Starting material B) in the method described above is a polyorganohydrogensiloxane comprising unit formula (B1): (R¹₃SiO_{1/2})ₐ(R¹₂SiO_{2/2})_{b}(R¹HSiO_{2/2})_{c}, where subscripts a, b, and c represent average numbers of each unit in the formula and have values such that a≤2, 20≤b≤60; 20≤c≤60; and each R¹ is an alkyl group of 1 to 12 carbon atoms. Alkyl groups for R¹ are exemplified by methyl, ethyl, propyl (including n-propyl and isopropyl), butyl (including n-butyl, isobutyl, sec-butyl, and t-butyl), pentyl, hexyl, heptyl, octyl, decyl, dodecyl and branched alkyl groups of 5 to 12 carbon atoms, as well as cyclic alkyl groups such as cyclopentyl and cyclohexyl. Alternatively, each R¹ may be a methyl group. Alternatively, the polyorganohydrogensiloxane may be linear, and subscript a=2. Alternatively, a quantity (b+c) may have a value such that 40≤(b+c)≤110. Alternatively, subscripts b and c may have values such that 21≤b≤57 and 20≤c≤44.

The silicon-bonded hydrogen (Si—H) content of the polyorganohydrogensiloxane can be determined using quantitative infra-red analysis in accordance with ASTM E168.

The silicon-bonded hydrogen to alkenyl (vinyl) ratio is frequently used to determine amounts of starting materials when relying on a hydrosilylation reaction. Generally, this is determined by calculating the total weight % of alkenyl groups in the starting materials, e.g. vinyl [V] and the total weight % of silicon bonded hydrogen [H] in the starting materials and given the molecular weight of hydrogen is 1 and of vinyl is 27 the molar ratio of silicon bonded hydrogen to vinyl is 27 [H]/[V].

Suitable polyorganohydrogensiloxanes for use herein are exemplified by:
(i) α,ω-trimethylsiloxy-terminated poly(dimethylsiloxane/methylhydrogensiloxane),
(ii) α,ω-trimethylsiloxy-terminated poly(methylhydrogensiloxane), and
(iii) a combination of two or more thereof.

Linear polyorganohydrogensiloxanes are also commercially available, such as those available from Gelest, Inc. of Morrisville, Pennsylvania, USA, for example, HMS-071, HMS-993; HMS-301, HMS-031, HMS-991, HMS-992, HMS-993, HMS-082, HMS-151, HMS-013, HMS-053, and HAM-301. Methods of preparing linear and branched polyorganohydrogensiloxanes suitable for use herein, such as hydrolysis and condensation of organohalosilanes, are well known in the art, as exemplified in: U.S. Pat. No. 2,823,218 to Speier, et al.; U.S. Pat. No. 3,957,713 to Jeram et al.; U.S. Pat. No. 4,329,273 to Hardman, et al.; U.S. Pat. No. 4,370,358 to Hayes, et al.; U.S. Pat. No. 4,707,531 to Shirahata; and U.S. Pat. No. 5,310,843 to Morita.

Starting material C) is a hydrosilylation reaction catalyst. This catalyst will promote a reaction between the alkenyl groups in A) the alkenyloxy-, aryl-terminated glycol ether (and when present D) the alkenyl-functional aromatic compound and/or E) the dialkenyl-terminated siloxane oligomer), and the silicon bonded hydrogen atoms in B) the polyorganohydrogensiloxane. Said catalyst comprises a platinum group metal. The platinum group metal may be selected from the group consisting of platinum, rhodium, ruthenium, palladium, osmium, and iridium. Alternatively, the platinum group metal may be platinum. The hydrosilylation reaction catalyst may be the platinum group metal or a compound or complex of the platinum group metal. For example, the hydrosilylation reaction catalyst may be a compound such as chloridotris(triphenylphosphane) rhodium (I) (Wilkinson's Catalyst), a rhodium diphosphine chelate such as [1,2-bis(diphenylphosphino)ethane]dichlorodirhodium or [1,2-bis(diethylphosphino)ethane]dichlorodirhodium, chloroplatinic acid (Speier's Catalyst), chloroplatinic acid hexahydrate, platinum dichloride, or a complex of such a compound with an alkenyl-functional organopolysiloxane such as 1,3-diethenyl-1,1,3,3-tetramethyldisiloxane complexes with platinum (Karstedt's Catalyst) or Pt (0) complex in tetramethyltetravinylcyclotetrasiloxane (Ashby's Catalyst). Alternatively, the compound or complex may be microencapsulated in a matrix or coreshell type structure. Hydrosilylation reaction catalysts are known in the art, for example, as described in PCT Patent Application Publication WO2021/081822 and the references cited therein. Hydrosilylation reaction catalysts are commercially available, for example, SYL-OFF™ 4000 Catalyst and SYL-OFF™ 2700 are available from Dow Silicones Corporation of Midland, Michigan, USA.

The amount of C) the hydrosilylation reaction catalyst is sufficient to catalyze hydrosilylation reaction of the alkenyl groups in starting material A) (and starting material D), the aromatic compound, when present) with the silicon bonded hydrogen atoms of B) the polyorganohydrogensiloxane. The amount of C) the hydrosilylation reaction catalyst may be sufficient to provide 1 ppm to 1,000 ppm of platinum group metal based on combined weights of starting materials A), B), C) (and when present D) and/or E)) used in the method. Alternatively, the amount of C) the hydrosilylation reaction catalyst may be sufficient to provide 2 ppm to 50 ppm, alternatively 2 to 10 ppm of the platinum group metal on the same basis.

Starting material D) is an alkenyl-functional aromatic compound that may optionally be added during the method for synthesizing the SPE copolymer. Starting material D) differs from starting material A). Starting material D) may have formula D1):

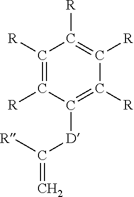

where each R is independently selected from the group consisting of H, a halogen atom, OH, methyl, and methoxy; D′ is a covalent bond, a group of formula —CH₂—, or a group of formula —CH₂—O—; and R″ is H or methyl. Alternatively, each R may be H or methyl. Alternatively, each R may be H.

Alternatively, starting material D) may have formula D2):

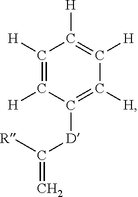

where D′ and R″ are as described and exemplified above.

For example, D) the alkenyl-functional aromatic compound may be selected from the group consisting of styrene, α-methyl styrene, eugenol, allylbenzene, allyl phenyl ether, 2-allylphenol, 2-chlorostyrene, 4-chlorostyrene, 4-methylstyrene, 3-methylstyrene, 4-t-butylstyrene, 2,4-dimethylstyrene, 2,5-dimethylstyrene, and 2,4,6-trimethylstyrene. Alternatively, starting material D) may be alpha methyl styrene, which is commercially available from, e.g., Sigma Aldrich, Inc. of St. Louis, Missouri, USA. One skilled in the art would recognize that starting material D) may optionally comprise a free radical polymerization inhibitor.

Starting material D) is optional, therefore, it may be absent, i.e., the amount used may be 0. Alternatively, when starting material D) the alkenyl-functional aromatic compound is present, the amount of D) the alkenyl-functional aromatic compound may be sufficient to provide a molar ratio of alkenyl groups from starting material D) to silicon bonded hydrogen atoms of starting material B) of >0/1 to 0.98/1.

Starting material E) is an optional dialkenyl-terminated siloxane oligomer of formula:

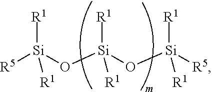

where R¹ is as described above, each R⁵ is an independently selected alkenyl group of 2 to 6 carbon atoms, and subscript m is 0 or 1. Alternatively, each R⁵ may be independently selected from vinyl, allyl, or hexenyl. Alternatively, subscript m may be 0. Examples of suitable oligomers include divinyltetramethyldisiloxane (MViMVi), which is available from Dow.

Starting material E) is optional). The amount of starting material E) may be sufficient to provide a molar ratio of alkenyl groups from starting material E) to silicon bonded hydrogen atoms of starting material B) of ≥0/1 to 0.1/1, alternatively 0.001/1 to 0.002/1. Alternatively, starting material E) may be omitted.

Starting material F) is an optional solvent. The solvent may be added to facilitate introduction of certain starting materials, such as C) the hydrosilylation reaction catalyst. Solvents that can be used herein are those that help fluidize the starting materials but essentially do not react with the starting materials. The solvent may be selected based on solubility of the starting materials and volatility of the solvent. The solubility refers to the solvent being sufficient to dissolve and/or disperse a starting material.

Suitable solvents include polyorganosiloxanes with suitable vapor pressures, such as hexamethyldisiloxane, octamethyltrisiloxane, hexamethylcyclotrisiloxane and other low molecular weight polyorganosiloxanes, such as 0.5 to 1.5 cSt DOWSIL™ 200 Fluids and DOWSIL™ OS FLUIDS, which are commercially available from Dow.

Alternatively, the solvent may comprise an organic solvent. The organic solvent can be an alcohol such as methanol, ethanol, isopropanol, butanol, or n-propanol; a ketone such as acetone, methylethyl ketone, or methyl isobutyl ketone; an aromatic hydrocarbon such as benzene, toluene, ethylbenzene or xylene; an aliphatic hydrocarbon such as heptane, hexane, or octane; a glycol ether such as propylene glycol methyl ether, dipropylene glycol methyl ether, propylene glycol n-butyl ether, propylene glycol n-propyl ether, or ethylene glycol n-butyl ether, a halogenated hydrocarbon such as dichloromethane, 1,1,1-trichloroethane or methylene chloride; chloroform; dimethyl sulfoxide; dimethyl formamide, acetonitrile; tetrahydrofuran; white spirits; mineral spirits; naphtha; n-methyl pyrrolidone; or a combination thereof.

The amount of solvent will depend on various factors including the type of solvent selected and the amount and type of other starting materials selected for use in the method. However, the amount of solvent may range from 1% to 99%, alternatively 2% to 90%, based on the weight of all starting materials used in step 1).

The SPE copolymer can be prepared by the method described above, and the SPE copolymer will be described in further detail, as follows. The SPE copolymer comprises unit formula: (R¹₃SiO_{1/2})ₐ(R¹₂SiO_{2/2})_{b}(R¹R²SiO_{2/2})_{c}, where subscripts a, b, and c, and R¹ are as described above. In the unit formula for the SPE copolymer, each R² is independently selected from the group consisting of H, formula E1′), formula D1′), and formula A1′), where
formula E1′) is

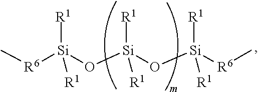

where R¹ and subscript m are as described above and each R⁶ is a divalent hydrocarbon group;
formula D1′) is

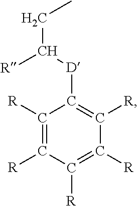

where R, D′, and R″ are as described above; and
formula A1′) is

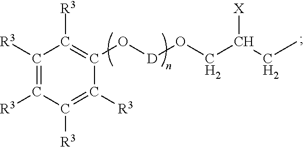

where X, D, R³, and subscript n are as described above; and with the proviso that at least one R² per molecule has formula A1′). One skilled in the art would recognize that formula E1′) is a group derived from E) the alkenyl-terminated siloxane oligomer; formula D1′) is a group derived from D) the alkenyl-functional aromatic compound; and formula A1′) is derived from A) the alkenyloxy-, aryl-terminated glycol ether, each as described above and used in the method to synthesize the SPE copolymer. One skilled in the art would further recognize that when the alkenyl groups (R⁵) of starting material E1) undergo hydrosilylation reaction with silicon bonded hydrogen atoms of starting material B), branching between sites on a molecule of B) the polyorganohydrogensiloxane and/or between different molecules of the polyorganohydrogensiloxane will be created, such that both ends of the group of formula E1′) are bonded to silicon atoms via hydrosilylation of the alkenyl groups of starting material (E) with silicon bonded hydrogen atoms from B) the polyorganohydrogensiloxane. Formula E1′) may impart branching to the SPE copolymer.

Alternatively, in the unit formula above, each R² may be independently selected from the group consisting of H, formula D1′) and formula A1′). Alternatively, each R² may be independently selected from the group consisting of formula D1′) and formula A1′). Alternatively, each R² may be an independently selected group of formula A1′).

Alternatively, each R may be H, and formula D1′) may be formula D2′):

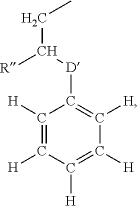

where R″ and D′ are as described above.

Alternatively, each R³ may be hydrogen, and formula A1′) may be formula A2′):

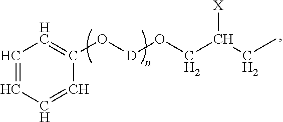

where X, D, and subscript n are as described above.

The method described above may be used to control the properties of the SPE copolymer produced, e.g., by varying the selection of B) the polyorganohydrogensiloxane with varying amounts of silicon bonded hydrogen atoms, and by varying the amounts of starting material A), and when present starting materials D) and/or E). However, the method may be used to produce an SPE copolymer with one or more of the following properties: >50 mol % of all instances of R² per molecule have formula D1′), alternatively 93 mol % to 95 mol % of all instances of R² per molecule have formula D1′). Alternatively, a balance to 100 mol % of all instances of R² per molecule may have formula A1′). Alternatively, each instance of R² may have formula A1′). Alternatively, >50 mol % of all instances of R² per molecule may have formula D2′), alternatively 90 mol % to 94 mol % of all instances of R² per molecule may have formula D2′). Alternatively, a balance to 100 mol % of all instances of R² per molecule may have formula A2′), e.g. <50 mol %, alternatively 6 mol % to 10 mol % of R² per molecule may have formula A2′). Alternatively, each instance of R² may have formula A2′).

The SPE copolymer may be useful as a defoamer for aqueous coating systems and printing inks, as disclosed in, e.g., U.S. Pat. No. 6,858,663, in addition to, or instead of, the siloxane glycol copolymer described therein. Alternatively, the SPE copolymer described herein may be used as an antifoam, either neat, or in a foam control formulation. For example, the SPE copolymer described herein may be used in addition to, or instead of, the siloxane polymer or copolymer in any of the foam control formulations of U.S. Pat. Nos. 6,521,586; 7,105,581; 7,550,514; 7,566,750; 7,619,043; 8,222,303; and 9,518,003. Alternatively, the SPE copolymer may be used as an antifoam (either neat or in a foam control formulation) in a liquid laundry detergent composition, such as a transparent liquid laundry detergent. For example, the SPE copolymer may be used in the liquid laundry detergent such as those as described in European Patent 3 210 663 and U.S. Pat. No. 10,407,647.

The foam control formulation may comprise: A) the SPE copolymer described above; B) a hydrophobic filler; and C) a silicone resin. The foam control formulation may optionally further comprise an additional starting material, in addition to, or instead of the hydrophobic filler and the silicone resin.

Starting material B) that may be used in the foam control formulation is a hydrophobic filler. Hydrophobic fillers include inorganic fillers, e.g., silica, ground quartz, zeolites, Al₂O₃, TiO₂, ZrO₂, and combinations thereof, such as aluminosilicates. Alternatively, the hydrophobic filler comprises silica. The silica may comprise fumed silica or precipitated silica. The silica may have a specific surface area of at least 50 m²/g, alternatively 50 to 500 m²/g. For example, precipitated silica or fumed silica having a specific surface area of 90 to 300 m²/g may be used. Some of the fillers mentioned above are not hydrophobic in nature but can be used if made hydrophobic. Treating the filler to render it hydrophobic may be done either in situ (i.e. when dispersed in a solvent or with the other starting materials used to make the foam control formulation), or by pre-treatment of the filler before mixing with the other starting materials in the foam control formulation. The filler may be treated, e.g. by treatment with a fatty acid or by the use of methyl substituted organo-silicon materials. Suitable hydrophobing agents include polydimethylsiloxanes, dimethylsiloxane polymers which are end-blocked with silanol or silicon-bonded alkoxy groups, hexamethyldisilazane, hexamethyldisiloxane and silicone resins, e.g., MQ resins, described below. Hydrophobing may be performed at a temperature of at least 80° C. Alternatively, MQ resins can be used as the silicone resin and as the hydrophobing agent for silica filler. The silica filler may have an average particle size of 0.5 μm to 50 μm, alternatively 2 μm to 30 μm, and alternatively 5 μm to 25 μm. Silica fillers are known and are commercially available, both in hydrophilic form and in hydrophobic form. Suitable hydrophobic fillers are disclosed, for example, in EP Patent Publication 3 210 663 A, U.S. Pat. Nos. 6,521,586 and 11,318,182. The amount of the hydrophobic filler (e.g., silica) in the foam control formulation may be 0.5% to 50% by weight based on weight of A) the SPE copolymer, alternatively 1% to 15%, alternatively 1% to 10%, and alternatively 2% to 8%. Furthermore, the amounts of B) filler and C) silicone resin may be sufficient to provide a weight ratio of C) silicone resin/B) filler of 1/10 to 20/1, alternatively 1/5 to 10/1, and alternatively 1/2 to 6/1.

In the foam control formulation, C) the silicone resin may comprise, alternatively consist essentially of, alternatively consist of monofunctional (M) units of formula R⁴₃SiO_{1/2}, where each R⁴ is an independently selected monovalent hydrocarbon group and tetrafunctional (Q) units of formula SiO_{4/2}. Suitable monovalent hydrocarbon groups for R⁴ are exemplified by alkyl groups of 1 to 6 carbon atoms and aryl groups of 6 to 10 carbon atoms. Suitable alkyl groups include methyl, ethyl, propyl and butyl; and suitable aryl groups include phenyl. Alternatively, each R⁴ may be independently selected from the group consisting of methyl and phenyl. Alternatively, each R⁴ may be methyl. When prepared, the silicone resin comprises the M and Q units described above, and the silicone resin further comprises units with silanol (silicon bonded hydroxyl) groups and may comprise neopentamer of formula Si(OSiR⁴₃)₄, where R⁴ is as described above. Si²⁹ Nuclear Magnetic Resonance (NMR) spectroscopy, as described in U.S. Pat. No. 9,593,209 at col. 32, Reference Example 2, may be used to measure molar ratio of M and Q units, where said ratio is expressed as {M(resin)+(M(neopentamer)}/{Q(resin)+Q(neopentamer)} and represents the molar ratio of the total number of triorganosiloxy groups (M units) of the resinous and neopentamer portions of the silicone to the total number of silicate groups (Q units) in the resinous and neopentamer portions. The silicone resin may comprise amounts of M and Q units such that the molar ratio of M to Q units (M/Q ratio) is 0.4/1 to 2.5/1, alternatively 0.4/1 to 1.1/1, and alternatively 0.5/1 to 0.8/1. For example, M/Q ratio may be selected to customize the silicone resin for different applications, e.g., when the foam control formulation is used in a laundry detergent composition, M/Q ratio may be 0.5/1 to 0.8/1. The silicone resin may optionally further comprise trifunctional (T) units of formula R⁴SiO_{3/2}, and/or difunctional (D) units of formula R⁴₂SiO₂₂, where R⁴ is as described above, in addition to the M units and Q units described above. Alternatively, no more than 20% of all units in the silicone resin are D units.

The Mn of the silicone resin depends on various factors including the types of hydrocarbon groups represented by R⁴ that are present. The Mn of the silicone resin refers to the number average molecular weight measured using GPC according to the procedure in U.S. Pat. No. 9,593,209 at col. 31, Reference Example 1, when the peak representing the neopentamer is excluded from the measurement. The Mn of the silicone resin may be greater than 3,000 g/mol, alternatively >3,000 g/mol to 12,000 g/mol. Alternatively, Mn of the silicone resin may be 4,500 g/mol to 7,500 g/mol. Alternatively, the silicone resin may have an Mw>6,000 g/mol, alternatively >9,000 g/mol, alternatively at least 13,500 g/mol, while at the same time, the silicone resin may have Mw up to 36,000 g/mol, alternatively up to 24,000 g/mol, alternatively up to 22,500 g/mol, and alternatively up to 15,000 g/mol.

U.S. Pat. No. 8,580,073 at col. 3, line 5 to col. 4, line 31, is hereby incorporated by reference for disclosing silicone resins, which are suitable for use in the foam control formulation herein. The silicone resin be prepared by any suitable method, such as cohydrolysis of the corresponding silanes or by silica hydrosol capping methods. The silicone resin may be prepared by silica hydrosol capping processes such as those disclosed in U.S. Pat. No. 2,676,182 to Daudt, et al.; U.S. Pat. No. 4,611,042 to Rivers-Farrell et al.; and U.S. Pat. No. 4,774,310 to Butler, et al. The method of Daudt, et al. described above involves reacting a silica hydrosol under acidic conditions with a hydrolyzable triorganosilane such as trimethylchlorosilane, a siloxane such as hexamethyldisiloxane, or mixtures thereof, and recovering a silicone resin having M units and Q units. The resulting silicone resins generally contain from 2 to 5 percent by weight of hydroxyl groups.

The silicone resin prepared as described above typically contains silicon bonded hydroxyl groups, i.e., of formulae, HOSi3/2 and/or (HO)ₓR⁴₍₃₋ₓ₎SiO_{1/2}, where subscript x is 1, 2, or 3. The silicone resin may comprise up to 2% of silicon bonded hydroxyl groups. The concentration of silicon bonded hydroxyl groups present in the polyorganosilicate resin may be determined using FTIR spectroscopy according to ASTM Standard E-168-16. For certain applications, it may be desirable for the amount of silicon bonded hydroxyl groups to be below 0.7%, alternatively below 0.3%, alternatively less than 1%, and alternatively 0.3% to 0.8%. Silicon bonded hydroxyl groups formed during preparation of the silicone resin can be converted to trihydrocarbyl siloxy groups, such as trimethylsiloxy groups, in a process comprising reacting the silicone resin with a silane, disiloxane, or disilazane containing the appropriate terminal group (said process may be referred to as capping, thereby producing a capped silicone resin). Silanes containing hydrolyzable groups may be added in molar excess of the quantity required to react with the silicon bonded hydroxyl groups on the silicone resin.

Alternatively, the silicone resin may further comprise 2% or less, alternatively 0.7% or less, and alternatively 0.3% or less, and alternatively 0.3% to 0.8% of units represented by formula XSiO_{3/2} and/or XR⁴₂SiO_{1/2} where R⁴ is as described above, and X represents a hydrolyzable substituent, such as hydroxyl or alkoxy. The silicone resin may be capped to reduce the content of hydrolyzable substituents by reacting the product of Daudt, et al. with an unsaturated organic group-containing endblocking agent and an endblocking agent free of aliphatic unsaturation. Examples of endblocking agents include, but are not limited to, silazanes, siloxanes, and silanes. Suitable silicone resins may be as described, for example, in EP Patent Publication 3210663A, U.S. Patent Application Publication 2009/0137446, and U.S. Pat. No. 6,521,586).

The silicone resin may be present in the foam control formulation at 1% to 50% by weight based on weight of A) the SPE copolymer, alternatively 2% to 30% and alternatively 4% to 15%, on the same basis. The silicone resin can be added into the foam control formulation as a solution in a non-volatile solvent, for example an alcohol such as dodecanol or 2-butyl-octanol or an ester such as octyl stearate. The resin solution prepared in a volatile solvent, e.g., xylene, can be united with the non-volatile solvent and the volatile solvent may be removed by stripping or by other forms of separation. The non-volatile solvent may optionally be left in the foam control formulation. Alternatively, the silicone resin may be dissolved in an equal amount of non-volatile solvent or less, alternatively no more than 50% its weight of solvent. Alternatively, the silicone resin in an amount of 50% to 90% may be dissolved in a non-volatile solvent, in an amount of 10% to 50% by weight of the combination of silicone resin and solvent. The silicone resin can alternatively be added in solution in a volatile solvent followed stripping off the solvent. Alternatively, the silicone resin can be added into the foam control formulation in the form of solid particles, for example, spray dried particles. Spray dried silicone resins are available commercially, for example of average particle size 10 μm to 200 μm.

The foam control formulation may optionally further comprise an additional starting material, such as a solvent exemplified by polypropylene glycol, a water dispersible carrier, a water-miscible liquid, a binder, an encapsulant, a cyclic siloxane, a thickening agent, water, a surfactant, a preservative, a water-insoluble organic compound, or a combination of two or more thereof. The water-insoluble organic compound has a boiling point >100° C. at ambient pressure and is exemplified by mineral oils, natural oils, isoparaffins, polyisobutylenes, fatty acid esters such as octyl stearate and dodecyl palmitate, and organic waxes, e.g., polyethylene waxes and microcrystalline waxes, salts of aliphatic carboxylic acids. The amount of additional starting material depends on various factors including the desired end use of the foam control formulation, however the additional starting material may be used in the foam control formulation at 0 to 1000 parts by weight per 100 parts by weight of A) the SPE copolymer, B) hydrophobic filler, and C) silicone resin combined. Suitable optional starting materials that may be added are exemplified by those disclosed in U.S. Pat. Nos. 6,521,586; 7,550,514; 10,407,647 and 11,383,182.

The foam control formulation may be made in any convenient way, such as by mixing the starting materials under shear. The amount of shear is sufficient to provide good dispersion of B) the hydrophobic filler and C) the silicone resin in A) the SPE copolymer, but not so much that particles of B) the filler and/or C) the silicone resin would be broken, thus possibly making them less effective, or exposing surfaces which are not hydrophobic. Where the filler needs to be made hydrophobic in situ, the manufacturing process of the foam control formulation may include a heating stage, optionally under reduced pressure, in which the filler and the treating agent are mixed together in part or all of A) the SPE copolymer, and optionally in the presence of a suitable catalyst, where useful. The foam control formulation may be provided as a simple mixture comprising A), B), and C), and any optional additional starting materials as described above. Alternatively, the foam control formulation may be provided in an alternative form, such as a solution, a solid, a dispersion, or an emulsion.

For example, the foam control formulation may be provided as an emulsion, e.g., when the foam control formulation will be used in an aqueous composition, such as a liquid laundry detergent composition. For example, such an emulsion may comprise a dispersed phase comprising A) the SPE copolymer (as described above) in an amount of 5 to 80 wt %, based on weight of the emulsion, a continuous phase comprising water, a surfactant, and optionally an additive selected from the group consisting of a preservative, a viscosity modifier, a protective colloid, and a thickener. The dispersed phase may optionally further comprise B) the hydrophobic filler and C) the silicone resin, as described above. The emulsion may be made by any convenient means such as those disclosed in U.S. Pat. No. 6,521,586 and the references cited therein, by varying appropriate starting materials.

Alternatively, the foam control formulation may be provided as a water-dispersible composition in which A) the SPE copolymer, B) the hydrophobic filler, and C) the silicone resin are dispersed in a water-dispersible carrier such as an alkylene glycol or mineral oil. Alternatively, due to the presence of the group of formula A1′), a separate water-dispersible carrier may be unnecessary, and A) the SPE copolymer may be used neat as an antifoam. Alternatively, the foam control formulation may be provided in a solid form, such as a powder or granule. Alternative forms of foam control formulations may be prepared as described in U.S. Pat. No. 6,521,586 and the references cited therein by varying appropriate starting materials.

The SPE copolymer (either neat or in the foam control formulation) may be incorporated into a cleaning composition. Such cleaning compositions may be provided in a variety of forms including but not limited to liquid, gel, paste, bar, granular and powder forms. Such cleaning compositions may be used in a variety of cleaning applications including but not limited to laundry, cookware and tableware (including dishware and flatware), hard surfaces along with personal care such as body and hair washing.

Alternatively, the cleaning composition may be a laundry detergent composition, such as a liquid laundry detergent composition. The laundry detergent composition comprises i) the SPE copolymer described above, or the foam control formulation (which contains the SPE copolymer) described above, and ii) a detersive surfactant. Representative detersive surfactants are known in the art and are described, for example, in Mccutcheon's Emulsifiers and Detergents, 1989 Annual, published by M.C. Publishing Co. Applicable surfactants include: non-ionic (e.g. polysaccharides, oxylates, amine oxides, fatty acid amides), amphoteric, zwitterionic, cationic (alkylammonium salts) and anionic (e.g. sulfonates, polyalkoxylated carboxylates) surfactants. The laundry detergent composition may optionally further comprise an additional starting material selected from the group consisting of an anti-redeposition agent, a brightener, a chelating agent, an enzyme, a bacteriostat, a solvent, a pH adjusting agent, an opacifier, a perfume, a dye, a color stabilizer, a bacteriacide, a soil release agent, a softening agent, a soap, a carrier, a builder, a structurant, an adjunct, a hydrotrope, a dispersant, a rheology modifier, and a combination of two or more thereof. The laundry detergent composition may comprise 0.001 wt % to 5.0 wt %, alternatively 0.01 wt % to 4.0 wt %, and alternatively 0.01 wt % to 2.0 wt % of the SPE copolymer, or the foam control formulation, described above; with the balance of the laundry detergent being the detersive surfactant and optionally one or more of the additional starting materials described above. The SPE copolymer and/or the foam control formulation described above may be used in known detergent compositions, such as those disclosed in U.S. Pat. Nos. 6,521,586 and 11,383,182.

### Examples

The following examples are provided to illustrate the invention to one skilled in the art and are not to be construed as limiting the scope of the invention set forth in the claims. Starting materials used in these examples are defined below in Table 1.

TABLE 1
Starting Materials

| Starting | | |
|---|---|---|
| Material | Description | Source |
| ALIQUAT ™ | N-Methyl-N,N,N-trioctylammonium chloride, | Sigma Aldrich |
| 336 | CAS No. 63393-96-4 | |
| Allyl Chloride | 3-Chloropropene, CAS No. 107-05-1 | Sigma Aldrich |
| Methallyl | 3-chloro-2-methyl-1-propene, CAS No. 563-47-3 | Sigma Aldrich |
| Chloride | | |
| MagSil | Magnesium Silicate, CAS No.14807-96-6. | Sigma Aldrich |
| DOWANOL ™ | 2-Phenoxyethanol, CAS No. 122-99-6 | Dow |
| Eph | | |
| DOWANOL ™ | Propylene Glycol Phenyl Ether, CAS No. 770-35-4 | Dow |
| PPh | | |
| DOWANOL ™ | Di Ethyleneglycol Phenyl Ether, CAS No. 104-68-7 | Dow |
| DiEPh | | |
| DOWANOL ™ | Di Propyleneglycol Phenyl Ether, CAS No. | Dow |
| DiPPh | 51730-94-0 | |
| A-1) EPh allyl | (2-(allyloxy)ethoxy)benzene of formula | Prepared as |
| ether | C₆H₅—O—CH₂—CH₂—O—CH₂—CH═CH₂ | described below |
| | | in Example 1 |
| A-2) PPh allyl | (2-(allyloxy)propoxy)benzene of formula | Prepared as |
| ether | C₆H₅—O—CH₂—CH(CH₃)—O—CH₂—CH═CH₂. | described below |
| | | in Example 2 |
| A-3) DiEPh | (2-(2-(allyloxy)ethoxy)ethoxy)benzene of formula | Prepared as |
| allyl ether | C₆H₅—O—CH₂—CH₂—O—CH₂—CH₂— | described below |
| | O—CH₂—CH═CH₂ | in Example 3 |
| | with refractive index 1.504 | |
| A-4) DiPPh | (2-(2-(allyloxy)propoxy)propoxy)benzene of formula | Prepared as |
| allyl ether | C₆H₅—O—CH₂—CH(CH₃)—O—CH₂— | described below |
| | CH(CH₃)—O—CH₂—CH═CH₂ | in Example 4 |
| A-5) EPh | (2-((2-methylallyl)oxy)ethoxy)benzene of formula | Prepared as |
| methallyl ether | C₆H₅—O—CH₂—CH₂—O—CH₂—C(CH₃)═CH₂. | described below |
| | | in Example 5 |
| A-6) PPh | (2-((2-methylallyl)oxy)propoxy)benzene of formula | Prepared as |
| methallyl ether | C₆H₅—O—CH₂—CH(CH₃)—O—CH₂—C(CH₃)═CH₂. | described below |
| | | in Example 6 |
| B-1) | Bis-trimethylsiloxy-terminated | Dow |
| M₂D₃₈D^{H}₃₃ | poly(dimethyl/methylhydrogen)siloxane copolymer | |
| | having, per molecule, an average of 38 units of formula | |
| | (Me₂SiO_{2/2}) and an average of 33 units of formula | |
| | (MeHSiO_{2/2}). | |
| D-1) AMS | Alpha methyl styrene, CAS No. 98-83-9 | |
| C-1) catalyst | mixture of 53% to 71% of 1,3-diethenyl-1,1,3,3- | Dow |
| | tetramenthyldisiloxane complexes with platinum and | |
| | 29% to 46% of tetramethyldivinyldisiloxane | |
| C-2) Pt catalyst | Chloroplatinic acid diluted in isopropanol | Dow |
| in IPA | | |
| B-2) | Bis-trimethylsiloxy-terminated | Dow |
| M₂D_{52.5}D^{H}_{21.1} | poly(dimethyl/methylhydrogen)siloxane copolymer | |
| | having, per molecule, an average of 52.5 units of | |
| | formula (Me₂SiO_{2/2}) and an average of 21.1 units of | |
| | formula (MeHSiO_{2/2}). | |
| B-3) | Bis-trimethylsiloxy-terminated | Dow |
| M₂D_{23.1}D^{H}₂₀ | poly(dimethyl/methylhydrogen)siloxane copolymer | |
| | having, per molecule, an average of 23.1 units of | |
| | formula (Me₂SiO_{2/2}) and an average of 20 units of | |
| | formula (MeHSiO_{2/2}). | |
| B-4) | Bis-trimethylsiloxy-terminated | Dow |
| M₂D_{21.4}D^{H}₅₀ | poly(dimethyl/methylhydrogen)siloxane copolymer | |
| | having, per molecule, an average of 21.4 units of | |
| | formula (Me₂SiO_{2/2}) and an average of 50 units of | |
| | formula (MeHSiO_{2/2}). | |
| B-5) | Bis-trimethylsiloxy-terminated | Dow |
| M₂D₅₇D^{H}₄₄ | poly(dimethyl/methylhydrogen)siloxane copolymer | |
| | having, per molecule, an average of 57 units of formula | |
| | (Me₂SiO_{2/2}) and an average of 44 units of formula | |
| | (MeHSiO_{2/2}). | |
| MQ Resin (I) | Capped resin comprising M^{Me} units and Q units, with a | Dow |
| | Mw of 21,400 g/mol by GPC and a M/Q ratio of 0.72/1 | |
| | in an amount of 60 wt % dissolved in 40 wt % octyl | |
| | stearate | |
| MQ Resin (II) | Resin comprising M^{Me} units and Q units, with a Mw of | Dow |
| | 19,000 g/mol by GPC and a M/Q ratio of 0.96/1 in an | |
| | amount of 60 wt % dissolved in 40 wt % octyl stearate | |
| MQ Resin (III) | Resin comprising M^{Me} units and Q units, with a Mw of | Dow |
| | 7,400 g/mol by GPC and a M/Q ratio of 1.04/1 in an | |
| | amount of 60 wt % dissolved in 40 wt % octyl stearate | |
| MQ Resin (IV) | Resin comprising M^{Me} units and Q units, with a Mw of | Dow |
| | 16,800 g/mol by GPC and a M/Q ratio of 0.96/1 in an | |
| | amount of 60 wt % dissolved in 40 wt % octyl stearate | |
| Filler | precipitated SiO₂ (≥97%) having a D50 particle size of | Evonik under |
| | 6.5 μm | tradename |
| | | SIPERNAT ™ |
| | | D10 |

In this Example 1, (2-(allyloxy) ethoxy)benzene (A-1) EPh allyl ether) was prepared as follows: A 3-L round bottom flask with an overhead stirrer, water-cooled condenser, addition funnel and a nitrogen bubbler was placed in a temperature-controlled heating mantle and charged with 804.6 g (5.82 moles) of DOWANOL™ EPh, 19.39 g of Aliquat™ 336, and 621.65 g (8.12 moles) of allyl chloride. The clear yellow solution was stirred with a Teflon™ paddle and charged with 833.1 g (10.4 moles) of 50% aqueous sodium hydroxide dropwise over about 1 hour. The temperature rose from 21 to 50° C. over the course of the addition. A smooth white slurry formed. The mixture was warmed to 65 to 70° C. GC analysis of the upper organic phase after three hours found 6.0 area % of allyl chloride, 0.43 area % of DOWANOL™ EPh, and 90.3 area % of EPh allyl ether. After cooling to ambient temperature, the white slurry was diluted with 665.5 g of water, the mixture was transferred to a 3-L separatory funnel, and the lower aqueous phase (1666.4 g), which contained some heavy white solid precipitate, was removed. The organic phase was washed with 205.3 g of water, and the lower aqueous phase (245.6 g) was removed. The organic phase (1173.1 g) was mixed with 14.0 g of MagSil, and the slurry filtered under vacuum through filter paper to afford 1137.7 g of a clear yellow filtrate. The filtrate was charged to a 2-L round bottom flask equipped with a magnetic stirrer and a 6″ tall vacuum-jacketed and silvered Vigreux column with a water-cooled distillate condenser. A temperature-controlled heating mantle was attached to the flask, and vacuum was applied using a dry ice-protected Edwards vacuum pump. A fore cut (10.41 g) was collected at a head temperature of 100° C. with a pot temperature of 112° C. at 1.9 torr. The product cut was collected in a 2-L receiving flask at a head temperature of 98 to 105° C., a pot temperature of 110 to 117° C., and a pressure of 1.5 to 2 torr until no more distillate could be collected to afford 984.4 g (5.52 moles, 94.9% yield) of (2-allyloxy) ethoxybenzene (2-allyloxyethylphenyl ether, CAS #93066-80-9) at >99 area % purity by GC analysis.

In this Example 2, (2-(allyloxy) propoxy)benzene (A-2) PPh allyl ether) was prepared as follows: A 3-L round bottom flask with an overhead stirrer, water-cooled condenser, addition funnel and a nitrogen bubbler was placed in a temperature-controlled heating mantle and charged with 872.2 g (5.73 moles) of DOWANOL™ PPh, 22.43 g of Aliquat™ 336, and 604.4 g (7.90 moles) of allyl chloride. GC analysis found 33.2 area % of allyl chloride and 62.0 area % of DOWANOL™ PPh. The clear yellow solution was stirred with a Teflon™ paddle for the dropwise addition of 820.7 g (10.3 moles) of 50% aqueous sodium hydroxide over about 1 hour. The temperature rose from 21 to 37° C. over the course of the addition, and a white slurry was formed. The mixture was stirred and warmed gently to 50 to 60° C.; the maximum temperature reached was 70° C. Two hours after completion of the base addition, GC analysis of the upper organic phase found 23.4 area % of allyl chloride, 37.9 area % of DOWANOL™ PPh, and 36.4 area % of PPh allyl ether. An additional charge of 6.4 g of Aliquat™ M336 was added. GC analysis of the upper organic phase after stirring overnight at 55° C. found 4.1 area % of allyl chloride, 3.8 area % of DOWANOL™ PPh, and 85.0 area % of PPh allyl ether. An additional charge of 2.47 g of Aliquat™ 336 was added. GC analysis after three hours at 55° C. did not show additional conversion. Warming to 70 to 75° C. did not improve conversion. After cooling to ambient temperature, the white slurry was diluted with 826.3 g of water, the mixture was transferred to a 3-L separatory funnel, and the lower aqueous phase (1830.9 g), which contained some heavy white solid precipitate, was removed. The organic phase (1220.3 g) was mixed with 34.1 g of MagSil, and the slurry filtered under vacuum through filter paper to afford 1140.1 g of a clear yellow filtrate. The filtrate was charged to a 2-L round bottom flask equipped with a magnetic stirrer and a 6″ tall vacuum-jacketed and silvered Vigreux column with a water-cooled distillate condenser. A temperature-controlled heating mantle was attached to the flask, and vacuum was applied using a dry ice-protected Edwards vacuum pump. A fore cut (92.55 g, 93.8 area % of the PPh allyl ether by GC analysis) was collected at a head temperature of 40 to 100° C. with a pot temperature of 100 to 115° C. at 2.5 torr. The product cut was collected in a 2-L receiving flask at a head temperature of 96 to 98° C., a pot temperature of 105 to 110° C., and a pressure of 2 to 2.5 torr until no more distillate could be collected to afford 904.0 g (4.70 moles, 82.0% yield) of (2-(allyloxy) propoxy)benzene at 96.6 area % purity (3.3 area % DOWANOL™ PPh) by GC analysis.

In this Example 3, 2-(2-allyloxy) ethoxy) ethoxy)benzene was prepared as follows: A 2-L round bottom flask with an overhead stirrer, water-cooled condenser, addition funnel and a nitrogen bubbler was placed in a temperature-controlled heating mantle and charged with 403.92 g of phenyl glycol ether (~70% DOWANOL™ DIEPh, 15% DOWANOL™ EPh), 8.15 g of Aliquat™ 336, and 265.54 g of allyl chloride. GC analysis found 34.2 area % of allyl chloride, 12.9 area % of DOWANOL™ EPh, and 52.9 area % of DOWANOL™ DiEPh. The clear yellow solution was stirred with a Teflon™ paddle, warmed to 50° C., and charged with 408 g of 50% aqueous sodium hydroxide dropwise. The temperature rose to 60° C. over the course of the addition. A smooth white slurry formed. The mixture was warmed to 60 to 70° C. GC analysis of the upper organic phase after three hours found 5.9 area % of allyl chloride, 17.4 area % of EPh allyl ether, 19.4 area % of unreacted DOWANOL™ DiEPh, and 62.9 area % of DiEPh allyl ether. GC analysis of the upper organic phase after stirring overnight found 0.67 area % of allyl chloride, 18.0 area % of EPh allyl ether, 0.94 area % of unreacted DOWANOL™ DiEPh, and 65.4 area % of DiEPh allyl ether. After cooling to ambient temperature, the white slurry was diluted with 400 mL of water, the mixture was transferred to a 3-L separatory funnel, and the lower aqueous phase (874.4 g), which contained some heavy white solid precipitate, was removed. The organic phase was washed with 100 mL of water, and 112.0 g of aqueous phase was removed. The organic phase (541.36 g) was mixed with 25.8 g of anhydrous magnesium sulfate, and the slurry filtered under vacuum through filter paper to afford 492.93 g of a clear yellow filtrate. The filtrate was charged to a 1-L round bottom flask equipped with a magnetic stirrer and a short path distillation head with a water-cooled distillate condenser. A temperature-controlled heating mantle was attached to the flask, and vacuum was applied using a dry ice-protected Edwards vacuum pump. The product cut was collected in a 1-L receiving flask at a head temperature of 115 to 127° C., a pot temperature of 133 to 135° C. and a pressure of 1.3 to 4.4 torr until no more distillate could be collected to afford 429.91 g (88% yield assuming 100% pure DiEPh) of (2-(2-allyloxy) ethoxy) ethoxy)benzene (20.3 area % EPh allyl ether; 71.2 area % DiEPh allyl ether by GC analysis).

In this Example 4, (2-(2-allyloxy) propoxy) propoxy)benzene was prepared as follows: A 2-L round bottom flask with an overhead stirrer, water-cooled condenser, addition funnel and a nitrogen bubbler was placed in a temperature-controlled heating mantle and charged with 429.91 g of a phenyl glycol ether (95% DiPPh, 5% DOWANOL™ PPh), 8.92 g of Aliquat™ 336, and 243.0 g of allyl chloride. GC analysis found 28.8 area % of allyl chloride, 3.4 area % of DOWANOL™ PPh, and 62.3 area % of DiPPh. The clear yellow solution was stirred with a Teflon™ paddle was charged with 372.0 g of 50% aqueous sodium hydroxide dropwise over 17 minutes. The temperature rose from 25 to 34° C. A smooth white slurry formed. The mixture was warmed to 60 to 70° C. GC analysis of the upper organic phase after three hours found 5.7 area % of allyl chloride, 4.7 area % of PPh allyl ether, 10.3 area % of DiPPh, and 68.2 area % of DiPPh allyl ether. GC analysis of the upper organic phase after stirring overnight found 1.9 area % of allyl chloride, 4.7 area % of PPh allyl ether, 7.6 area % of DiPPh, and 73.6 area % of DiPPh allyl ether. After cooling to ambient temperature, the white slurry was diluted with 532.58 g of water, the mixture was transferred to a 3-L separatory funnel, and the clear lower aqueous phase (984.6 g) was removed. The organic phase was washed with 159.31 g of water, and 151.9 g of aqueous phase was removed. The organic phase (666.88 g) was mixed with 39.52 g of anhydrous magnesium sulfate, and the slurry filtered under vacuum through filter paper to afford 522.54 g of a clear yellow filtrate. The filtrate was charged to a 1-L round bottom flask equipped with a magnetic stirrer and a short path distillation head with a water-cooled distillate condenser. A temperature-controlled heating mantle was attached, and vacuum was applied using a dry ice-protected Edwards vacuum pump. The product cut was collected in a 1-L receiving flask at a head temperature of 110 to 122° C., a pot temperature of 130 to 135° C., and a pressure of 1 torr until no more distillate could be collected to afford 479.83 g (94% yield assuming 100% pure DiPPh) of (2-(2-allyloxy) propoxy) propoxy)benzene (7.2 area % PPh allyl ether; 79.5 area % DiPPh allyl ether by GC analysis).

In this Example 5, (2-((2-methylallyl)oxy) ethoxy)benzene (A-5) EPh methallyl ether) was prepared as follows: A 3-L round bottom flask with an overhead stirrer, water-cooled condenser, addition funnel and a nitrogen bubbler was placed in a temperature-controlled heating mantle and charged with 800.8 g (5.79 moles) of DOWANOL™ EPh, 13.42 g of Aliquat™ 336, and 737.5 g (8.14 moles) of 3-chloro-2-methyl-1-propene. GC analysis found 43.7 area % of 3-chloro-2-methyl-1-propene and 56.0 area % of DOWANOL™ EPh. The clear yellow solution was stirred with a Teflon™ paddle and charged with 863.0 g (10.8 moles) of 50% aqueous sodium hydroxide dropwise over about 1 hour. The temperature rose from 18 to 36° C. over the course of the addition. A white slurry formed. The mixture was warmed to 60° C. and allowed to stir overnight. GC analysis of the upper organic phase found 10.3 area % of 3-chloro-2-methyl-1-propene, 0.64 area % of DOWANOL™ EPh, and 87.6 area % of EPh methallyl ether. The white slurry was diluted with 549.5 g of water, the mixture was transferred to a 3-L separatory funnel, and the lower aqueous phase (1581.5 g), which contained some heavy white solid precipitate, was removed at 40° C. The organic phase (1298.7 g) was mixed with 27.65 g of MagSil, and the slurry filtered under vacuum through filter paper to afford 1234.2 g of a clear yellow filtrate. The filtrate was charged to a 2-L round bottom flask equipped with a magnetic stirrer and a 6″ tall vacuum-jacketed and silvered Vigreux column with a water-cooled distillate condenser. A temperature-controlled heating mantle was attached, and vacuum was applied using a dry ice-protected Edwards vacuum pump. A fore cut (29.45 g) was collected at a head temperature of 99 to 117° C. with a pot temperature of up to 127° C. at 4.5 torr. The product cut was collected in a 2-L receiving flask at a head temperature of 116 to 117° C., a pot temperature of 120 to 127° C. and a pressure of 3.9 to 4.1 torr until no more distillate could be collected to afford 1010.6 g (5.26 moles, 90.7% yield) of (2-((2-methylallyl)oxy) ethoxy)benzene at 99.6 area % purity by GC analysis.

In this Example 6, (2-((2-methylallyl)oxy) propoxy)benzene (A-6) PPh methallyl ether) was prepared as follows: A 3-L round bottom flask with an overhead stirrer, water-cooled condenser, addition funnel and a nitrogen bubbler was placed in a temperature-controlled heating mantle and charged with 828.5 g (5.44 moles) of DOWANOL™ PPh and 672.2 g (7.42 moles) of 3-chloro-2-methyl-1-propene. GC analysis found 40.0 area % of 3-chloro-2-methyl-1-propene and 60.0 area % of DOWANOL™ PPh. The clear solution was stirred with a Teflon™ paddle, charged with 20.00 g of Aliquat™ 336, and warmed to 44° C. for the dropwise addition of 808.2 g (10.1 moles) of 50% aqueous sodium hydroxide over about 1.5 hours. The temperature rose to 49° C. over the course of the addition, and the heating mantle was removed to control the temperature. A white slurry formed. The mixture was stirred at 50 to 60° C. Two hours after completion of the base addition, GC analysis of the upper organic phase found 25.4 area % of 3-chloro-2-methyl-1-propene, 31.7 area % of DOWANOL™ PPh, and 40.9 area % of PPh methallyl ether. GC analysis of the upper organic phase after stirring overnight at 50° C. found 9.0 area % of 3-chloro-2-methyl-1-propene, 8.7 area % of DOWANOL™ PPh, and 78.7 area % of PPh methallyl ether. An additional 12.44 g of Aliquat™ 336 and 99.9 g of 50% aqueous sodium hydroxide were added; GC analysis of the upper organic phase after stirring overnight at 50° C. found 4.2 area % of 3-chloro-2-methyl-1-propene, 2.7 area % of DOWANOL™ PPh, and 87.6 area % of PPh methallyl ether. After cooling to ambient temperature, the white slurry was diluted with 863.6 g of water, the mixture was transferred to a 3-L separatory funnel, and the lower aqueous phase (1946.2 g), which contained some heavy white solid precipitate, was removed. The organic phase (1261.6 g) was mixed with 44.4 g of MagSil, and the slurry filtered under vacuum through filter paper to afford 1180.6 g of a clear yellow filtrate. The filtrate was charged to a 2-L round bottom flask equipped with a magnetic stirrer and a 6″ tall vacuum-jacketed and silvered Vigreux column with a water-cooled distillate condenser. A temperature-controlled heating mantle was attached to the flask, and vacuum was applied using a dry ice-protected Edwards vacuum pump. A fore cut (27.87 g, 21.6 area % of the PPh methallyl ether by GC analysis) was collected at a head temperature of 91 to 100° C. with a pot temperature of 97 to 111° C. at 7 to 1.9 torr. The product cut was collected in a 2-L receiving flask at a head temperature of 102 to 105° C., a pot temperature of 119 to 142° C. and a pressure of 1.7 to 2.1 torr until no more distillate could be collected to afford 1044.6 g (5.06 moles, 93.1% yield) of (2-((2-methylallyl)oxy) propoxy)benzene at 97.3 area % purity (2.7 area % DOWANOL™ PPh) by GC analysis.

In this Example 7, copolymer sample 1 was synthesized as follows: The polyorganohydrogensiloxane (B-1) M₂D₃₈D^{H}₃₃, 1 eqv. 55 g) and 5% of total D-1) AMS needed (2.16 g, total to be 43.3 g) were charged into a 250 mL, 3 neck round bottom flask equipped with a condenser, a magnetic bar and N₂ inlet. The content was stirred at RT until a homogenous mixture was obtained. To insert C-1) the catalyst, a solution of 2-0719 was prepared in IPA (5000 ppm). Temperature was set at 100° C. while the catalyst solution was added (amount sufficient to provide 10 ppm Pt) when temperature reached 70° C. At T=100° C., 10.28 g of D-1) AMS was added. A second portion of D-1) AMS was added with a syringe 15 min later (10.28 g), followed by an amount of catalyst solution sufficient to provide 2 ppm of Pt. A third portion of D-1) AMS was added with a syringe 15 min later (10.28 g), likewise followed by the addition of an amount of catalyst solution sufficient to provide 2 ppm Pt. The last portion of D-1) AMS was added with a syringe 15 min later (10.28 g), followed by the addition of an amount of catalyst solution sufficient to provide 8 ppm Pt. 5 h 30 min later, Temperature was raised to 110° C. and a last addition of catalyst solution in an amount sufficient to provide 4 ppm Pt was done. After 1 h 30 min, the reaction was stopped. Total C-1) catalyst used was sufficient to provide 26 ppm of Pt and the total time elapsed was 7 h 45 min.

In this Example 8, copolymer sample 2 was synthesized as follows: The polyorganohydrogensiloxane (B-1) M₂D₃₈D^{H}₃₃, 1 eqv. 55 g) and A-5) EPh methallyl ether (prepared as described above in Example 5) needed (2 eqv., 4.27 g) were charged into a 250 mL, 3 neck round bottom flask equipped with a condenser, a magnetic bar and N₂ inlet. AMS (31 eqv.) was added in 4 portions (10.16 g each). The content was stirred at RT until a homogenous mixture was obtained. To insert the catalyst, a solution of C-1) catalyst was prepared in IPA (5000 ppm). Temperature was set at 85° C. while the catalyst solution (in an amount sufficient to provide 12 ppm Pt) was added when temperature reached 75° C. At T=85° C., 10.16 g of D−1) AMS was added from a dropping funnel and the temperature increased to 92.3° C. In 5 minutes, temperature dropped to 85° C. again so that the second portion of D-1) AMS (10.16 g) was added dropwise. As no temperature increase was observed, additional catalyst solution (in an amount sufficient to provide 8 ppm Pt) was inserted and the temperature increased by 27° C. and decreased back to the initial value. This cycle was done 4 times in total with additional catalyst solution inserted at each step (to provide an amount of 24 ppm Pt total). After 4 h 35 min, ¹H-NMR analysis showed insufficient D-1) AMS in the medium while there were available SiH sites to react. This was probably due to an unplanned leaking of D-1) AMS from the system. Additional D-1) AMS was charged to the reactor (7 eqv., 9.2 g) followed by catalyst solution in an amount sufficient to provide 12 ppm of Pt. Temperature was raised to 105° C. Reaction was run for another 3 hours and then completed.

In this Example 9, copolymer sample 9 was synthesized as follows: The SiH source (B-1) M₂D₃₈D^{H}₃₃, 1 eqv. 55 g) and A-6) PPh methallyl ether (prepared as described above in Example 6 in an amount of 2 eqv., 4.58 g) were charged into a 250 mL, 3 neck round bottom flask equipped with a condenser, a magnetic bar and N₂ inlet. D-1) AMS (31 eqv.) was added in 4 portions (10.16 g each). The contents of the flask were stirred at RT until a homogenous mixture was obtained. To insert the catalyst, a solution of C-1) catalyst was prepared in IPA (5000 ppm). Temperature was set at 85° C. while the catalyst solution (in an amount sufficient to provide 12 ppm Pt) was added when temperature reached 75° C. The rest of the reaction was done in the same way as in Example 8 to prepare copolymer sample 8, HT210. Addition of 4 D-1) AMS portions was completed in 5 h 15 min with 26 ppm of Pt. Conversion was incomplete. Reaction was restarted and heated up to 105° C., followed by addition of excess D-1) AMS (26.2 g) and sufficient catalyst solution to provide 8 ppm Pt. After 6 hours of reaction, synthesis was complete and excess D-1) AMS was removed by stripping.

In this Example 10, copolymer sample 10 was synthesized as follows: The SiH source (B-1) M₂D₃₈D^{H}₃₃, 1 eqv. 50 g) and A-6) PPh methallyl ether (10% of total amount, 6.9 g) were charged into a 250 mL, 3 neck round bottom flask equipped with a condenser, a magnetic bar and N₂ inlet. The content was stirred at RT until a homogenous mixture was obtained. To insert the catalyst, a solution of C-1) catalyst was prepared in IPA (5000 ppm). Temperature was set at 100° C. while the catalyst solution (amount sufficient to provide 24 ppm Pt) was added when temperature reached 75° C. At T=100° C., 15.5 g of A-6) PPh methallyl ether was added dropwise. A second portion was added 1 hour later, followed by a third portion addition another hour later. Sufficient catalyst solution to provide 6 ppm Pt was added as there was no exotherm observed. Temperature was raised to 110° C. 4 mL toluene was added to aid refluxing. After 4 h 30 min in total, the last portion of A-6) PPh methallyl ether was added, and the reaction was run for an additional 25 minutes and then stopped.

In this Example 11, copolymer sample 11 was synthesized as follows: The SiH source (B-1) M₂D₃₈D^{H}₃₃, 1 eqv. 43.4 g) and 10% of A-5) EPh methallyl ether prepared as described above in Example 5 (5.55 g) were charged into a 250 mL, 3 neck round bottom flask equipped with a condenser, a magnetic bar and N₂ inlet. The content was stirred at RT until a homogenous mixture was obtained. To insert the catalyst, a solution of C-1) catalyst was prepared in IPA (5000 ppm). Temperature was set at 85° C. while the catalyst solution (in an amount sufficient to provide 24 ppm Pt) was added when temperature reached 75° C. After reaching T=85° C., a first portion of the A-5) EPh methallyl ether was added (12.5 g) through a dropping funnel. In 5 hours of a reaction time, three portions of the A-5) EPh methallyl ether were added along with catalyst solution sufficient to provide 4 ppm additional Pt. Temperature was raised to 100° C. and the reaction was run for 1.5 h more and then stopped. Reactor was reheated to 100° C. 4 mL IPA was added together with the last portion of the A-5) EPh methallyl ether and an additional amount of catalyst solution sufficient to provide 2 ppm of Pt. After 7 hours of running, the reaction was stopped. Reaction was still incomplete. On a consecutive day, the reactor was reheated to 100° C., 0.6 g A-5) EPh methallyl ether was added together with catalyst solution in an amount sufficient to provide 4 ppm of Pt, and the reaction was run for another 7 hours. In order to force to completion, reaction was restarted at 110° C. An amount of catalyst solution sufficient to provide 2 ppm Pt was added, and 9 mL toluene was added for refluxing. 7 hours of reaction time was complete. Finally, solvents were stripped, and the reaction was completed.

In this Example 12, copolymer sample 12 was synthesized as follows: The SiH source (B-1) M₂D₃₈D^{H}₃₃, 1 eqv. 55 g) and A-2) PPh allyl ether (2 eqv., 4.69 g) were charged into a 250 mL, 3 neck round bottom flask equipped with a condenser, a magnetic bar and N₂ inlet. The content was stirred at RT until a homogenous mixture was obtained. To insert the catalyst, a solution of C-1) catalyst was prepared in IPA (5000 ppm). Temperature was set at 85° C. while the catalyst solution (in an amount sufficient to provide 4 ppm Pt) was added when temperature reached 75° C. D-1) AMS (31 eqv.) was added in 4 portions (10.16 g each). First 2 portions of D-1) AMS were added at 85° C. with an amount of catalyst solution sufficient to provide an additional 2 ppm Pt at each time. A third addition did not require extra catalyst, while the last portion was also followed by addition of catalyst solution in an amount sufficient to provide 2 ppm of Pt. Overall reaction time was 5 h 40 m with 10 ppm Pt. However, D-1) AMS was insufficient as observed in previous cases. Reactor was heated to 85° C. D-1) AMS (30 g) was added dropwise into the reactor followed by an amount of catalyst solution sufficient to provide 8 ppm Pt. After 7 h 30 m, the reaction was stopped and excess D-1) AMS was stripped.

In this Example 13, copolymer sample 13 was synthesized as follows: The SiH source (B-1) M₂D₃₈D^{H}₃₃, 1 eqv. 55 g) and A-1) EPh allyl ether (2 eqv., 4.35 g) were charged into a 250 mL, 3 neck round bottom flask equipped with a condenser, a magnetic bar and N₂ inlet. The content was stirred at RT until a homogenous mixture was obtained. To insert the catalyst, a solution of C-1) catalyst was prepared in IPA (5000 ppm). Temperature was set at 85° C. while the catalyst solution (in an amount sufficient to provide 4 ppm Pt) was added when temperature reached 75° C. D-1) AMS (31 eqv.) was added in 4 portions (10.16 g each) as follows. At 85° C., a first portion was added followed by catalyst solution in an amount sufficient to provide an additional 4 ppm Pt. With this addition, temperature raised to 120° C. After temperature was stabilized at 85° C., the remaining 3 portions of D-1) AMS were added in a row, and the reaction was let to run after each addition for 1.5 hours. Reaction was completed in 7 hours.

In this Example 14, copolymer sample 14 was synthesized as follows: The SiH source (B-1) M₂D₃₈D^{H}₃₃, 1 eqv. 50 g) and A-2) PPh allyl ether (7 g, 10% of the overall amount) were charged into a 250 mL, 3 neck round bottom flask equipped with a condenser, a magnetic bar and N₂ inlet. The content was stirred at RT until a homogenous mixture was obtained. To insert the catalyst, a solution of C-1) catalyst was prepared in IPA (5000 ppm). Temperature was set at 85° C. while the catalyst solution (in an amount sufficient to provide 4 ppm Pt) was added when temperature reached 75° C. At T=85° C., first portion of the A-2) PPh allyl ether (15.8 g) was added dropwise. The same step was repeated 4 times in total. The reaction was complete after approximately 7 hours.

In this Example 15, SPE copolymer sample 15 (SPE-Ph-EO1) was prepared as follows: The hydrosilylation reaction was carried out in a 250 mL 4-neck round bottom flask equipped with a digital overhead stirrer, thermocouple, stopper, condenser, and nitrogen inlet. The system was heated by a heating mantle with a J-KEM temperature controller. To the pot was added A-1) EPh allyl ether (7 g, 1^{st} portion, 10%) and M₂D₃₈D^{H}₃₃ (45 g). The mixture was heated to 70° C. under nitrogen. Catalyst C-1) catalyst (in amount sufficient to provide 4 ppm Pt) was added. This reaction was exothermic, and the temperature went up to 98° C. Temperature then decreased to 73° C. in 1 h. A 2^{nd} portion of A-1) EPh allyl ether (15 g) was added dropwise via a funnel. Temperature went up to 89° C. and decreased to 73° C. in 45 min. Another 15 g of A-1) EPh allyl ether was added and the temperature increased to 83° C. in minutes. Catalyst C-1) in an amount sufficient to provide 4 ppm pf Pt was added, temperature was raised to 90° C., and 3 mL of isopropanol was added to trigger the reaction. After 1 hour, one last portion of 15 g EPh allyl ether was added together with additional amount of C-1) catalyst to provide 4 ppm of Pt and the reaction was run for 1 more hour and then stopped.

In this Example 16, sample SPE Copolymer Sample 16 (SPE-AMS-mPh-PO1) was prepared as follows: Firstly, a mixture of D-1) AMS and A-6) PPh methallyl ether (monomer blend) was prepared using equal amounts of each. The hydrosilylation reaction was carried out in a 250 mL 4-neck round bottom flask equipped with a digital overhead stirrer, thermocouple, stopper, condenser, and nitrogen inlet. The system was heated by a heating mantle with a J-KEM temperature controller. To the pot was added the monomer blend (6 g, 1^{st} portion, 10%) and M₂D₃₈D^{H}₃₃ (55 g). The mixture was stirred under nitrogen for 5 minutes and then the temperature was set to 100° C. Catalyst C-1) in an amount sufficient to provide 12 ppm Pt was added when temperature reached 70° C. The rest of the mixture of D-1) and A-6) (monomer blend) was added dropwise in 4 different portions (14.85 g each) and the exotherm trend was monitored with an IR probe. Each addition was followed by catalyst C-1) in an amount sufficient to provide 3-6 ppm of Pt, which caused an increase in temperature. Decrease and stabilization of temperature to 100° C. was waited before the addition of next monomer blend. Overall, the reaction was run for 5 hours and then stopped. On a second day, the flask was reheated to 100° C. and the reaction was run for an additional 3 hours with the addition of C-1) Catalyst sufficient to provide 3 ppm of Pt to go to completion (45 ppm Pt in total). Excess monomers were left in the mixture.

In this Example 17, SPE Copolymer Sample 17 was prepared as follows: The hydrosilylation reaction was carried out in a 250 mL 4-neck round bottom flask equipped with a mechanical overhead stirrer, thermocouple, stopper, condenser, and nitrogen inlet. The system was heated by a heating mantle with a PT-100 temperature controller. In the flask at RT were blended A-6) PPh methallyl ether (1.25 g, 1^{st} portion, 5%) and 30.01 g of M₂D_{52.5}D^{H}_{21.1}. The mixture was heated to 75° C. under nitrogen. After 25 minutes when the temperature reached 76° C., +6 ppm of Pt catalyst in IPA (5000 ppm active level) was added. This reaction was exothermic, and the temperature went up to 80° C. at 27 minutes. Set up the temperature to 100° C. At 53 minutes when the temperature reached 99.3° C., a 2^{nd} portion of A-6) PPh methallyl ether (5.54 g) was added dropwise via a funnel during 5 minutes. At 1 h02 when the temperature was at 101.7° C., a second dose of Pt catalyst in IPA (5000 ppm active level) was added (0.070 g/+5 ppm). Temperature reached 108° C. at 1 h04. At 2 h42 when the temperature reached 102.4° C., a 3^{nd} portion of A-6) PPh methallyl ether (6.17 g) was added dropwise via a funnel during 4 minutes. At 2 h55 when the temperature was at 103° C., a third dose of Pt catalyst in IPA (5000 ppm active level) was added (0.064 g/+5 ppm). Temperature reached 104.3° C. at 2 h56. At 3 h52 when the temperature reached 100.4° C., a 4th portion of A-6) PPh methallyl ether (5.87 g) was added dropwise via a funnel during 1 minute. At 4 h05 when the temperature was at 102.2° C., a fourth dose of Pt catalyst in IPA (5000 ppm active level) was added (0.05 g/+4 ppm). Temperature reached 103.6° C. at 4 h06. At 4 h37 when the temperature reached 103.1° C., the last portion of A-6) PPh methallyl ether (5.89 g) was added dropwise via a funnel during 1 minute. At 6 h38 with a temperature of 99.6° C., the reaction was stopped and a H+NMR was performed to see if there was still SiH unreacted. Two days after the reaction was restarted and at 1 h14 when the temperature reached 99.2° C., +3 ppm of Pt catalyst in IPA (5000 ppm active level) was added. At 3 h57 when the temperature was at 98.1° C., the reaction was stopped and another H+NMR was performed. This second NMR analysis confirmed there was no more SiH to react. In total 27.55 ppm of catalyst were used.

In this Example 18, SPE Copolymer Sample 18 was prepared as follows: The hydrosilylation reaction was carried out in a 250 mL 4-neck round bottom flask equipped with a mechanical overhead stirrer, thermocouple, stopper, condenser, and nitrogen inlet. The system was heated by a heating mantle with a PT-100 temperature controller. In the flask at room temperature were blended A-6) PPh methallyl ether (1.25 g, 1^{st} portion, 4%) and 25 g of M₂D_{23.1}D^{H}₂₀. The mixture was heated under nitrogen. After 16 minutes when the temperature reached 100.8° C., +6 ppm of Pt catalyst in IPA (5000 ppm active level) was added. This reaction was exothermic, and the temperature went up to 107.7° C. at 17 minutes. At 43 minutes when the temperature reached 97.3° C., a 2^{nd} portion of A-6) PPh methallyl ether (5.6 g) was added dropwise via a funnel during 8 minutes-temperature reached 110.2° C. At 53 minutes when the temperature was at 110.1° C., a second dose of Pt catalyst in IPA (5000 ppm active level) was added (0.059 g/+6 ppm). Temperature reached 112.7° C. at 54 minutes. At 2 h27 when the temperature reached 105.4° C., a 3^{nd} portion of A-6) PPh methallyl ether (6.22 g) was added dropwise via a funnel during 4 minutes. At 2 h47 minutes when the temperature reached 102° C., a 4th portion of A-6) PPh methallyl ether (6.54 g) was added dropwise via a funnel during 6 minutes. At 3 h33 when the temperature reached 102.4° C., a 5th portion of A-6) PPh methallyl ether (7 g) was added dropwise via a funnel during 1 minute. At 4 h18 when the temperature reached 102.4° C., the last portion of A-6) PPh methallyl ether (6.84 g) was added dropwise via a funnel during 5 minutes. At 4 h56 when the temperature was at 102.2° C., a third dose of Pt catalyst in IPA (5000 ppm active level) was added (0.03 g/+3 ppm). At 5 h37 with a temperature of 100.7° C., the reaction was stopped and a H+NMR was performed to see if there was still SiH unreacted. Next day (26.08.2022) the reaction was restarted and at 3 h29 when the temperature reached 103.2° C., +3 ppm of Pt catalyst in IPA (5000 ppm active level) was added. At 5 h45 when the temperature was at 105° C., a dose of Pt catalyst in IPA (5000 ppm active level) was added (0.026 g/+3 ppm). At 6 h40 when the temperature was at 103.6° C., a dose of Pt catalyst in IPA (5000 ppm active level) was added (0.021 g/+3 ppm). At 7 h13 when the temperature was at 103.4° C., the reaction was stopped and another H+NMR was performed. This second NMR analysis confirmed there was no more SiH to react. In total 21.49 ppm of catalyst were used.

In this Example 19, SPE Copolymer Sample 19 was prepared as follows: The hydrosilylation reaction was carried out in a 250 mL 4-neck round bottom flask equipped with a mechanical overhead stirrer, thermocouple, stopper, condenser, and nitrogen inlet. The system was heated by a heating mantle with a PT-100 temperature controller. In the flask at room temperature were blended A-6) PPh methallyl ether (2.5 g, 1^{st} portion, 6.5%) and 17.51 g of M₂D_{21.4}D^{H}₅₀. The mixture was heated to 100° C. under nitrogen. After 18 minutes when the temperature reached 100.5° C., +6 ppm of Pt catalyst in IPA (5000 ppm active level) was added. This reaction is exothermic, and the temperature went up to 115.2° C. at 19 minutes. At 35 minutes when the temperature reached 100.4° C., a 2^{nd} portion of A-6) PPh methallyl ether (5.6 g) was added dropwise via a funnel during 5 minutes. At 41 minutes when the temperature was at 100° C., a second dose of Pt catalyst in IPA (5000 ppm active level) was added (0.035 g/+3 ppm). Temperature reached 102.5° C. at 42 minutes. At 60 minutes when the temperature reached 100.2° C., a 3^{nd} portion of A-6) PPh methallyl ether (10.06 g) was added dropwise via a funnel during 3 minutes. At 2 h27 when the temperature reached 101.2° C., a 4th portion of A-6) PPh methallyl ether (6.03 g) was added dropwise via a funnel during 4 minutes. At 3 h13 when the temperature reached 100.8° C., a 5th portion of A-6) PPh methallyl ether (5.61 g) was added dropwise via a funnel during 2 minutes. At 4 h00 when the temperature reached 99.5° C., the last portion of A-6) PPh methallyl ether (8.47 g) was added dropwise via a funnel during 2 minutes. At 4 h22 when the temperature was at 100° C., a third dose of Pt catalyst in IPA (5000 ppm active level) was added (0.065 g/+6 ppm). At 5 h45 with a temperature of 100.2° C., the reaction was stopped and a H+NMR was performed to see if there was still SiH unreacted. Next day (15.09.2022) the reaction was restarted and at 54 minutes when the temperature reached 100° C., +6 ppm of Pt catalyst in IPA (5000 ppm active level) was added. At 1 h40 when the temperature was at 99° C., a dose of Pt catalyst in IPA (5000 ppm active level) was added (0.032 g/+3 ppm). At 4 h12 when the temperature was at 100.5° C., a dose of IPA was added (0.842 g) to increase compatibility between methallyl and SiH. At 5 h14 when the temperature was at 102.5° C., a dose of Pt catalyst in IPA (5000 ppm active level) was added (0.055 g/+5 ppm)—Temperature increase to 103.6 at 5 h16. At 6 h20 when the temperature was at 100° C., the reaction was stopped and another H+NMR was performed. This second NMR analysis confirmed there was no more SiH to react. In total 27.46 ppm of catalyst were used.

In this Example 20, SPE Copolymer Sample 20 was prepared as follows: The hydrosilylation reaction was carried out in a 250 mL 4-neck round bottom flask equipped with a mechanical overhead stirrer, thermocouple, stopper, condenser, and nitrogen inlet. The system was heated by a heating mantle with a PT-100 temperature controller. In the flask at room temperature were blended A-6) PPh methallyl ether (4.48 g, 1^{st} portion, 13.5%) and 25.65 g of M₂D_{57.5}D^{H}₄₄M. The mixture was heated to 100° C. under nitrogen. After 31 minutes when the temperature reached 97° C., +5 ppm of Pt catalyst in IPA (5000 ppm active level) was added. There was no exotherm observed in this example. At 44 minutes when the temperature was at 99.5° C., 0.34 g of IPA was added to increase compatibility between methallyl and SiH. Exotherm was observed (105.3° C.) at 52 minutes when the temperature controller was set at 102° C. At 1 h03 when the temperature reached 98.6° C., a 2^{nd} portion of A-6) PPh methallyl ether (5.99 g) was added dropwise via a funnel during 2 minutes. At 1 h29 when the temperature was at 100° C., a second dose of Pt catalyst in IPA (5000 ppm active level) was added (0.072 g/+5 ppm). At 1 h35 when the temperature reached 100.6° C., a 3^{nd} portion of A-6) PPh methallyl ether (11.08 g) was added dropwise via a funnel during 3 minutes. At 3 h42 when the temperature was at 101° C., a third dose of Pt catalyst in IPA (5000 ppm active level) was added (0.071 g/+5 ppm). At 3 h46 when the temperature reached 101.2° C., the last portion of A-6) PPh methallyl ether (11.54 g) was added dropwise via a funnel during 6 minutes. At 4 h27 when the temperature was at 101.5° C., a fourth dose of Pt catalyst in IPA (5000 ppm active level) was added (0.159 g/+13 ppm)—temperature reached 102.4° C. at 4 h29. At 6 h19 with a temperature of 99.7° C., the reaction was stopped and a H+NMR was performed to see if there was still SiH unreacted. This NMR analysis confirmed there was no more SiH to react. In total 24.51 ppm of catalyst were used.

In this Example 21, SPE Copolymer Sample 21 was prepared by repeating Example 17.

TABLE 3
Summary of Copolymer Samples made in Examples 7-21

| | | Ph- | | Ph | | |
|---|---|---|---|---|---|---|
| Copolymer | | Polyether | | ether | | AMS |
| Sample | SiH | type | Ph-polyether | Eqv. | AMS | eqv. |
| Example 7 | M₂D₃₈D^{H}₃₃ | None | None- | None | Yes | 33 |
| (comparative) | | | | | | |
| Example 8 | M₂D₃₈D^{H}₃₃ | methallyl | A-5) EPh | 2 | Yes | 31 |
| | | | methallyl | | | |
| | | | ether | | | |
| Example 9 | M₂D₃₈D^{H}₃₃ | methallyl | A-6) PPh | 2 | Yes | 31 |
| | | | methallyl | | | |
| | | | ether | | | |
| Example 10 | M₂D₃₈D^{H}₃₃ | methallyl | A-6) PPh | 33 | None | — |
| | | | methallyl | | | |
| | | | ether | | | |
| Example 11 | M₂D₃₈D^{H}₃₃ | methallyl | A5) EPh | 33 | None | — |
| | | | methallyl | | | |
| | | | ether | | | |
| Example 12 | M₂D₃₈D^{H}₃₃ | allyl | A-2) PPh | 2 | Yes | 31 |
| | | | allyl ether | | | |
| Example 13 | M₂D₃₈D^{H}₃₃ | allyl | A-1) EPh | 2 | Yes | 31 |
| | | | allyl ether | | | |
| Example 14 | M₂D₃₈D^{H}₃₃ | allyl | A-2) PPh | 33 | None | — |
| | | | allyl ether | | | |
| Example 15 | M₂D₃₈D^{H}₃₃ | allyl | A-1) EPh | 33 | None | — |
| | | | allyl ether | | | |
| Example 16 | M₂D₃₈D^{H}₃₃ | methallyl | A-6) PPh | 16.5 | Yes | 16.5 |
| | | | methallyl | | | |
| | | | ether | | | |
| Example 17 | M₂D_{52.5}D^{H}_{21.1} | methallyl | A-6) PPh | 21 | None | |
| | | | methallyl | | | |
| | | | ether | | | |
| Example 18 | M₂D_{23.1}D^{H}₂₀ | methallyl | A-6) PPh | 20 | None | |
| | | | methallyl | | | |
| | | | ether | | | |
| Example 19 | M₂D_{21.4}D^{H}₅₀ | methallyl | A-6) PPh | 50 | None | |
| | | | methallyl | | | |
| | | | ether | | | |
| Example 20 | M₂D₅₇D_{H44} | methallyl | A-6) PPh | 44 | None | |
| | | | methallyl | | | |
| | | | ether | | | |
| Example 21 | M₂D_{52.5}D^{H}_{21.1} | methallyl | A-6) PPh | 21 | None | |
| | | | methallyl | | | |
| | | | ether | | | |

In this Foam Control Example A, the SPE copolymers and comparative copolymer prepared as described above were evaluated either with silicone resin and silica, or without silicone resin and silica (neat) for their foam control performance, using the Quick Suds Test for Antifoam Performance. The Quick Suds Test for Antifoam Performance was performed as follows 300 mL of water at a defined water hardness (23° french hardness) was added in a rotating tube. Either the neat copolymer or 0.7 g of the detergent formulation in Table D containing the copolymer as an antifoam candidate was added. The tube was rotated for 9 minutes at 30 RPM. The foam height (cm) was then measured. Without antifoam candidate, the tube was full of foam (24 cm) at the end of the 9 minutes of rotation. The amount of copolymer added was either 0.1% or 0.5%, and the results of the Quick Suds Test are shown below in Tables 4 and 5.

TABLE D

| | Detergent |
|---|---|
| | Formulation |
| Anionic surfactant (Disponil LDBS 55 from BASF) | 19.5 |
| Anionic surfactant (Marlinat 248/28 from Sasol) | 13.5 |
| Nonionic surfactant (Dehydol LT7 from Dow) | 9 |
| Propylene glycol (Dow) | 4 |
| Triethanolamine (Aldrich) | 5 |
| Water | up to 100 |

TABLE 4
Quick Suds Test for Antifoam Performance of Neat SPE
Copolymers as Foam Control Agents

| | QST fluid | QST fluid in |
|---|---|---|
| | in 3/4 4% | 3/4 4% |
| Sample Tested | @0.1% | @0.5% |
| Copolymer Sample of Example 7 | 24 | 17 |
| (comparative) | | |
| SPE Copolymer Sample of Example 15 | 15.5 | 9 |
| SPE Copolymer Sample of Example 14 | 14.5 | 15 |
| SPE Copolymer Sample of Example 11 | 14 | 8.5 |
| SPE Copolymer Sample of Example 10 | 18 | 10 |
| SPE Copolymer Sample of Example 9 | 15 | 14 |
| SPE Copolymer Sample of Example 8 | 15.5 | 14 |
| SPE Copolymer Sample of Example 16 | 20 | 14 |

The data in Table 4 show that all of the SPE copolymers tested neat exhibited better foam control properties than the control (copolymer of Example 7, which had pendant groups derived from alpha methyl styrene but no pendant groups derived from alkenyloxy-, phenyl-terminated glycol ether). The SPE copolymers of this invention provided the unexpected benefit of providing good foam control properties in the absence of MQ resin and silica, which may make these SPE copolymers suitable for simpler foam control formulations than those foam control formulations containing silicone resin and hydrophobic filler, which are currently commercially available. Surprisingly, the SPE copolymers that had silicon bonded pendant groups derived from allyloxy, phenyl-terminated glycol ether but that did not contain pendant groups derived from alpha methyl styrene (i.e., the SPE copolymers of Examples 10, 11, 14, and 15) exhibited better foam control properties, particularly at 0.5% loading, than the SPE copolymers that contained pendant groups derived from both alpha methyl styrene and from allyloxy, phenyl-terminated glycol ethers (i.e., SPE copolymers of Examples 8, 9, and 16) under the conditions tested in this Example.

In this Foam Control Formulation Example I (FCF I), foam control formulation samples were prepared as follows: In a 20 mL plastic container suitable for the Hauschild Speed mixer, 8.7 g of a SPE copolymer (or comparative copolymer) synthesized as described above, 0.7 g of an MQ resin and 0.6 g of Sipernat D10-1 were weighed. The resulting blend was mixed for 30 seconds at 3500 RPM the first time. The plastic container was opened and inspected to check for potential silica aggregates. A second mix of 30 seconds at 3500 RPM was applied if needed to break up silica aggregates. Certain Foam Control Formulations prepared as described in this Example were evaluated using the Quick Suds Test, described below. The results are shown below in Table 5.

TABLE 5
Quick Suds Test Results of Foam Control Formulations
containing Resin and Filler.

| Foam Control Formulation | Copolymer | Ph ether | | QST |
|---|---|---|---|---|
| Sample No. | Sample Used | Eqv. | AMS | (cm) |
| FCF I-7 | Example 7 | None | Yes | 5.5 |
| | (comparative) | | | |
| Example FCF I-8 | SPE Copolymer of | 2 | Yes | 4.75 |
| | Example 8 | | | |
| Example FCF I-10 | SPE Copolymer of | 33 | None | 5 |
| | Example 10 | | | |
| Example FCF I-11 | SPE Copolymer of | 33 | None | 5.5 |
| | Example 11 | | | |
| Example FCF I-14 | SPE Copolymer of | 33 | None | 5.5 |
| | Example 14 | | | |
| Example FCF I-17 | SPE Copolymer of | 21 | None | 3.5 |
| | Example 17 | | | |
| Example FCF I-18 | SPE Copolymer of | 20 | None | 3 |
| | Example 18 | | | |
| Example FCF I-19 | SPE Copolymer of | 50 | None | 3.75 |
| | Example 19 | | | |
| Example FCF I-20 | SPE Copolymer of | 44 | None | 3 |
| | Example 20 | | | |
| Example FCF I-21 | SPE Copolymer of | 21 | None | 4 |
| | Example 21 | | | |

The data in Table 5 show that all SPE copolymers tested provided good foam control in a conventional foam control formulation containing silicone resin and silica filler, under the conditions tested. Certain SPE copolymers improved foam control performance over the comparative example. The SPE copolymers of Examples 17 to 21 improved foam control performance under the conditions tested in this Example (over the comparative copolymer) even though the SPE copolymers of Examples 17 to 21 did not contain any pendant groups derived from alpha methyl styrene.

In this Foam Control Formulation Example II, the foam control formulations prepared in Foam Control Formulation Example 1 were evaluated using the washing machine antifoam procedure described below. The results are shown below in Tables 6, 7, and 8

TABLE 6
Washing Machine Antifoam Performance Results

| | Example | Example | Example | Example | Example |
|---|---|---|---|---|---|
| | FCF I-7 | FCF I-8 | FCF I-9 | FCF I-12 | FCF I-13 |
| | (containing | (containing | (containing | (containing | (containing |
| | copolymer | SPE | SPE | SPE | SPE |
| | of | copolymer | copolymer | copolymer | copolymer |
| | Example 7) | of | of | of | of |
| Time | (com- | Exam- | Exam- | Exam- | Exam- |
| (minutes) | parative) | ple 8) | ple 9) | ple 12) | ple 13) |
| 0 | 0 | 0 | 0 | 0 | 0 |
| 5 | 7.5 | 5 | 5 | 2.5 | 5 |
| 10 | 25 | 22.5 | 10 | 10 | 10 |
| 15 | 27.5 | 27.5 | 10 | 25 | 17.5 |
| 20 | 27.5 | 30 | 17.5 | 27.5 | 22.5 |
| 25 | 32.5 | 30 | 20 | 30 | 32.5 |
| 30 | 32.5 | 37.5 | 25 | 37.5 | 35 |
| 35 | 40 | 42.5 | 30 | 42.5 | 45 |
| 40 | 40 | 45 | 35 | 47.5 | 47.5 |
| 45 | 45 | 47.5 | 37.5 | 52.5 | 50 |
| 50 | 50 | 52.5 | 42.5 | 55 | 57.5 |

The data in Table 6 show that SPE copolymers with silicon bonded pendant groups derived from both alpha methyl styrene and alkenyloxy-, phenyl-terminated glycol ethers provided good antifoam performance in the foam control formulations tested. Sample FCF I-9, in which the SPE copolymer of Example 9 was used and which contained silicon bonded pendant groups derived from A-6) PPh methallyl ether showed improved foam control performance over the control, which had silicon bonded pendant groups derived from alpha methyl styrene but not alkenyloxy-, phenyl-terminated glycol ether.

TABLE 7
Washing Machine Antifoam Performance Results

| | | | | | Example |
|---|---|---|---|---|---|
| | Example | Example | Example | Example | FCF |
| | FCF I-10 | FCF I-11 | FCF I-14 | FCF I-15 | I-7 |
| | (contained | (contained | (contained | (contained | (contained |
| | SPE | SPE | SPE | SPE | copolymer |
| | copolymer | copolymer | copolymer | copolymer | of |
| | of | of | of | of | Example 7) |
| Time | Example | Example | Example | Example | (com- |
| (minutes) | 10) | 11) | 14) | 15) | parative) |
| 0 | 0 | 0 | 0 | 0 | 0 |
| 5 | 20 | 22.5 | 5 | 27.5 | 7.5 |
| 10 | 32.5 | 40 | 20 | 42.5 | 25 |
| 15 | 35 | 47.5 | 40 | 55 | 27.5 |
| 20 | 40 | 55 | 50 | 62.5 | 27.5 |
| 25 | 45 | 60 | 55 | 90 | 32.5 |
| 30 | 52.5 | 87.5 | 60 | 100 | 32.5 |
| 35 | 57.5 | 100 | 80 | 100 | 40 |
| 40 | 62.5 | 100 | 95 | 100 | 40 |
| 45 | 72.5 | 100 | 100 | 100 | 45 |
| 50 | 77.5 | 100 | 100 | 100 | 50 |

The data in Table 7 showed that the SPE copolymers with silicon bonded pendant groups derived from alkenyloxy-, phenyl-terminated glycol ethers (but none derived from alpha methyl styrene) provided some foam control performance under the conditions tested in this Example, although it was not as good as the SPE copolymers containing silicon bonded pendant groups derived from both alpha methyl styrene and alkenyloxy-, phenyl-terminated glycol ethers (shown above in Table 6), under the conditions tested in this Example.

TABLE 8
Washing Machine Antifoam Performance Results

| | FCF I-9 | FCF I-16 | FCF I-10 | Example |
|---|---|---|---|---|
| | (containing | (containing | (containing | FCF I-7 |
| | SPE | SPE | SPE | (containing |
| | copolymer | copolymer | copolymer | copolymer of |
| Time | of | of | of | Example 7) |
| (minutes) | Example 9) | Example 16) | Example 10) | (comparative) |
| 0 | 0 | 0 | 0 | 0 |
| 5 | 5 | 10 | 20 | 7.5 |
| 10 | 10 | 27.5 | 32.5 | 25 |
| 15 | 10 | 32.5 | 35 | 27.5 |
| 20 | 17.5 | 37.5 | 40 | 27.5 |
| 25 | 20 | 45 | 45 | 32.5 |
| 30 | 25 | 55 | 52.5 | 32.5 |
| 35 | 30 | 72.5 | 57.5 | 40 |
| 40 | 35 | 77.5 | 62.5 | 40 |
| 45 | 37.5 | 87.5 | 72.5 | 45 |
| 50 | 42.5 | 100 | 77.5 | 50 |

The data in Table 8 show that the foam control formulation containing a SPE copolymer with 2 equivalents of pendant groups derived from the alkenyloxy-, phenyl-terminated glycol ether and 31 equivalents of pendant groups derived from alpha methyl styrene provided the best antifoam performance under the conditions tested. Foam control performance of this sample FCF I-9 was better than that of the comparative example (in which the copolymer had pendant groups derived from alpha methyl styrene, but not pendant groups derived from a alkenyloxy-, phenyl-terminated glycol ether). The other samples tested did show some foam control performance.

In this Foam Control Formulation Example III, the SPE copolymer prepared in Example 10 was formulated into foam control formulations containing different silicone resins. Samples were prepared as described in Foam Control Formulation Example I, but using the SPE copolymer of Example 10 and the silicone resins shown below in Table 9.

TABLE 9
Foam Control Formulations with the SPE Copolymer
of Example 10 and different Silicone Resins

| FCF III | FCF III | FCF III | FCF III |
|---|---|---|---|
| with MQ | with MQ | with MQ | with MQ |
| Resin (I) | Resin (II) | Resin (III) | Resin (IV) |
| 0 | 0 | 0 | 0 |
| 20 | 5 | 10 | 5 |
| 32.5 | 35 | 32.5 | 30 |
| 35 | 40 | 40 | 40 |
| 40 | 42.5 | 47.5 | 45 |
| 45 | 42.5 | 50 | 50 |
| 52.5 | 45 | 57.5 | 57.5 |
| 57.5 | 50 | 57.5 | 62.5 |
| 62.5 | 50 | 60 | 85 |
| 72.5 | 60 | 60 | 95 |
| 77.5 | 70 | 62.5 | 100 |

The washing machine antifoam procedure described below was completed on the samples in Table 9. Good antifoam performances were obtained using all MQ resins tested. MQ Resin (III) was found to provide better antifoam performance than MQ Resin (IV) when all other starting materials were the same under the conditions tested in this Example. No significant differences were observed between MQ Resin (I) versus MQ Resin (II) under the conditions tested.

In this Foam Control Formulation Example IV, the SPE copolymers of Examples 10 and 17 to 20 were formulated in foam control formulations using the procedure in Foam Control Formulation Example I, except for varying the SPE copolymer selected. The foam control formulations were evaluated in the washing machine antifoam procedure described below. The results are in Table 10.

TABLE 10
Varying Copolymer in Foam Control Formulations

| | FCF | FCF | FCF | FCF | FCF |
|---|---|---|---|---|---|
| | IV-17 | IV-18 | IV-19 | IV-10 | IV-20 |
| | with SPE | with SPE | with SPE | with SPE | with SPE |
| | Copoly- | Copoly- | Copoly- | Copoly- | Copoly- |
| | mer | mer | mer | mer | mer |
| | of | of | of | of | of |
| Time | Example | example | Example | example | Example |
| (minutes) | 17 | 18 | 19 | 10 | 20 |
| 0 | 0 | 0 | 0 | 0 | 0 |
| 5 | 20 | 20 | 20 | 0 | 10 |
| 10 | 55 | 40 | 40 | 30 | 30 |
| 15 | 95 | 50 | 50 | 40 | 40 |
| 20 | 100 | 60 | 60 | 50 | 47.5 |
| 25 | 100 | 75 | 60 | 50 | 52.5 |
| 30 | 100 | 90 | 70 | 57.5 | 57.5 |
| 35 | 100 | 100 | 100 | 60 | 67.5 |
| 40 | 100 | 100 | 100 | 72.5 | 90 |
| 45 | 100 | 100 | 100 | 95 | 100 |
| 50 | 100 | 100 | 100 | 100 | 100 |

The examples in Table 10 showed that use of a SPE copolymer that did not have silicon bonded pendant groups derived from alpha methyl styrene provided some foam control performance under the conditions tested in this Example.

### Quick Suds Test for Antifoam Performance

300 mL of water at a defined water hardness (23° french hardness) was added in a rotating tube. 0.7 g of the detergent formulation in Table D containing the copolymer as an antifoam candidate was added. The tube was rotated for 9 minutes at 30 RPM. The foam height (cm) was then measured. Without antifoam candidate, the tube was full of foam (24 cm) at the end of the 9 minutes of rotation.

TABLE D

| | Detergent |
|---|---|
| | Formulation |
| | amount (g) |
| Anionic surfactant (Disponil 55) | 19.5 |
| Anionic surfactant (Marlinat 248/28) | 13.5 |
| Nonionic surfactant (Dehydol LT7) | 9 |
| Propylene glycol (Dow) | 4 |
| Triethanolamine (Aldrich) | 5 |
| Water | up to 100 |

### Washing Machine Antifoam Procedure:

In a Miele W1914 containing 11 cleaned terry towels (dry weight of 2 Kg) or 16 cleaned terry towels (3.5 Kg), 50 g of detergent formulation described above in Table D with 0.1 wt % of antifoam was added with 15 liters of soft water unless otherwise stated. Hardness was manually adjusted for the wash by adding 5 mL of a Calcium ion solution (262 g of CaCl₂·2H₂O/Liter) and 19 mL of Magnesium ion solution (72 g MgCl₂/Liter). The 40° C. cotton program was used, with the spinning speed set at 1400 rpm. Foam height in the front window was monitored every five minutes through the whole wash cycle. This test was followed by 2 additional laundry cycles (temperature set at 95° C. and then 40° C.) to remove any antifoam residual and avoid detergent accumulation.

### INDUSTRIAL APPLICABILITY

The examples above demonstrate that the silicone-polyether copolymers described herein are useful as foam control agents. The copolymers may be used neat (e.g., without MQ resin and/or silica in a foam control formulation) and provide good foam control, as demonstrated in Foam Control Example A. Certain copolymers (e.g., the copolymers that had silicon bonded pendant groups derived from allyloxy, phenyl-terminated glycol ether but that did not contain pendant groups derived from an alpha methyl styrene) may provide better foam control when used neat than those copolymers having both silicon bonded pendant groups derived from allyloxy, phenyl-terminated glycol ether and silicon bonded pendant groups derived from an alpha methyl styrene, as shown in Table 4. Other copolymers e.g., the having both silicon bonded pendant groups derived from allyloxy, phenyl-terminated glycol ether and silicon bonded pendant groups derived from an alpha methyl styrene, may provide better foam control performance when formulated in a foam control formulation containing a filler (e.g., silica) and a silicone resin (e.g., MQ resin), as shown in Tables 5 and 7. Without wishing to be bound by theory, it is thought that the copolymers of this invention may be made with selections of starting materials to provide a copolymer that provides good foam control for various different applications, such as foam control formulations and/or detergent compositions.

### Definitions and Usage of Terms

All amounts, ratios, and percentages herein are by weight, unless otherwise indicated by the context of the specification. The articles ‘a’, ‘an’, and ‘the’ each refer to one or more, unless otherwise indicated by the context of specification. The singular includes the plural unless otherwise indicated by the context of the specification. The SUMMARY and ABSTRACT are hereby incorporated by reference. The amounts of all starting materials in a composition total 100%. The transitional phrases “comprising”, “consisting essentially of”, and “consisting of” are used as described in the Manual of Patent Examining Procedure Ninth Edition, Revision 08.2017, Last Revised January 2018 at section § 2111.03 I., II., and III. Any feature or aspect of the invention may be used in combination with any other feature or aspect recited herein. The abbreviations used herein have the definitions in Table 11.

TABLE 11
Abbreviations

| Abbreviation | Definitions |
|---|---|
| AMS | alpha methyl styrene |
| ° C. | degrees Celsius |
| cm | centimeter |
| D | Difunctional dimethylsiloxy unit |
| | of formula Me₂SiO_{2/2} |
| D^{H} | Difunctional methylhydrogensiloxy |
| | unit of formula MeHSiO_{2/2} |
| Dow | The Dow Chemical Company of |
| | Midland, Michigan, USA |
| eqv | equivalent |
| FTIR | Fourier transform infra-red |
| g | gram |
| GC | Gas chromatography |
| GPC | gel permeation chromatography |
| h | hour |
| IPA | isopropanol |
| L | liter |
| M^{Me} | Monofunctional trimethylsiloxy |
| | unit of formula Me₃SiO_{1/2} |
| Me | methyl |
| min | minute |
| mL | milliliter |
| mmol | millimole |
| Mn | number average molecular weight |
| | measured by GPC |
| Mw | weight average molecular weight |
| | measured by GPC |
| mPa · s | milliPascal seconds |
| NMR | nuclear magnetic resonance |
| PDI | Polydispersity index (calculated as Mw/Mn) |
| Ph | phenyl |
| ppm | parts per million by weight |
| RI | refractive index |
| RPM or rpm | revolutions per minute |
| RT | room temperature of 25 ± 5° C. |
| SPE | silicone polyether |
| μm | micrometers |
| Vi | vinyl |

1. A silicone-polyether copolymer comprising unit formula:
(R¹₃SiO_{1/2})ₐ(R¹₂SiO_{2/2})_{b}(R¹R²SiO_{2/2})_{c}, where
subscripts a, b, and c represent average numbers of each unit in the unit formula and have values such that
a=2;
b=20 to 60;
c=20 to 50;
each R¹ is an independently selected alkyl group of 1 to 12 carbon atoms; and
each R² is independently selected from the group consisting of H, formula E1′), formula D1′) and formula A1′), where
formula E1′) is 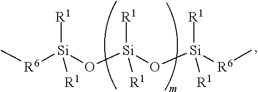
where R¹ is as described above, subscript m is 0 or 1, and each R⁶ is a divalent hydrocarbon group;
formula D1′) is 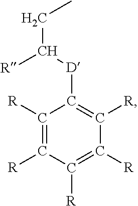
where
each R is independently selected from the group consisting of H, a halogen atom, OH, methyl, and methoxy;
D′ is a covalent bond, a group of formula —CH₂—, or a group of formula —CH₂—O—; and
R″ is H or methyl; and
formula A1′) is 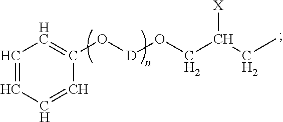
where
X is H or methyl,
D has empirical formula —C₂H₄— or —C₃H₆—, and
subscript n is 1, 2, or 3;
with the proviso that at least one instance of R² per molecule has formula A1′).

2. The copolymer of claim 1, where
each R¹ is methyl,
formula D1′) is 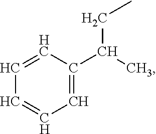
and
formula A1′) is 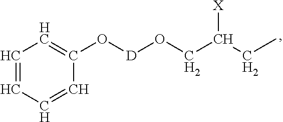
where
D is selected from —CH₂—CH₂— or —CH₂—CH(CH₃)—, and
X is as described above.

3. The copolymer of claim 2, where X is methyl, D is —CH₂—CH(CH₃)—, and >50 mol % of all instances of R² per molecule have formula D1′).

4. The copolymer of claim 3, where 93 to 95 mol % of R² have formula D1′), and 5 to 7 mol % of R² have formula A1′).

5. The copolymer of claim 1, where each instance of R² has formula A1′).

6. The copolymer of claim 1, where formula A1′) is selected from the group consisting of:

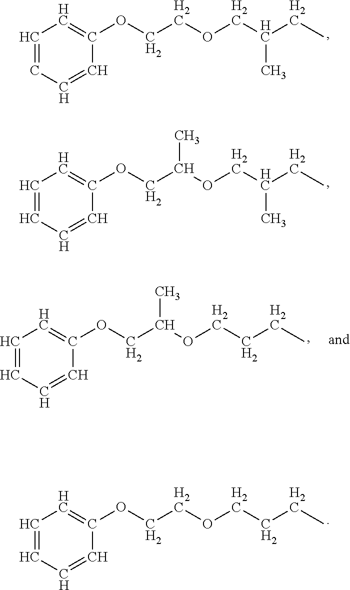 [SMILES: CCC(C)COCCOc1ccccc1 ; CCC(C)COC(C)COc1ccccc1 ; CCCCOC(C)COc1ccccc1 ; CCCCOCCOc1ccccc1]

7. (canceled)

8. A foam control formulation comprising:
A) the copolymer of claim 3;
0.5 to 50 wt %, based on weight of A) the copolymer, of B) a hydrophobic filler,
1 to 50 wt %, based on weight of A) the copolymer, of C) a silicone resin,
0 to 60 wt %, based on weight of C) the silicone resin, of D) an organic solvent in which the resin is soluble.

9. The foam control formulation of claim 8, further comprising an additional starting material selected from the group consisting of: a water dispersible carrier, a water-miscible liquid, a binder, an encapsulant, a cyclic siloxane, a thickening agent, water, a surfactant, a preservative, a water-insoluble organic compound, and a combination of two or more thereof.

10. A foam control formulation, wherein the foam control formulation is an emulsion comprising
a dispersed phase comprising A) the copolymer of claim 1 in an amount of 5 to 80 wt %, based on weight of the emulsion,
a continuous phase comprising water,
a surfactant, and
optionally an additive selected from the group consisting of a preservative, a viscosity modifier, a protective colloid, and a thickener.

11. A laundry detergent composition comprising:
i) the copolymer of claim 6, and
ii) a detersive surfactant.

12. The laundry detergent composition of claim 11, further comprising an additional starting material selected from the group consisting of an anti-redeposition agent, a brightener, a chelating agent, an enzyme, a bacteriostat, a solvent, a pH adjusting agent, an opacifier, a perfume, a dye, a color stabilizer, a bacteriacide, a soil release agent, a softening agent, a soap, a carrier, a builder, a structurant, an adjunct, a hydrotrope, a dispersant, a rheology modifier, and a combination of two or more thereof.

13. The laundry detergent composition of claim 12, where the laundry detergent composition is a liquid laundry detergent composition.

14. The laundry detergent composition of claim 11, where i) the copolymer or the foam control formulation is present in an amount of 0.001 weight % to 5 weight % based on weight of the laundry detergent composition.

15. A laundry detergent composition comprising:
i) the foam control formulation of claim 8, and
ii) a detersive surfactant.

16. The laundry detergent composition of claim 15, further comprising an additional starting material selected from the group consisting of an anti-redeposition agent, a brightener, a chelating agent, an enzyme, a bacteriostat, a solvent, a pH adjusting agent, an opacifier, a perfume, a dye, a color stabilizer, a bacteriacide, a soil release agent, a softening agent, a soap, a carrier, a builder, a structurant, an adjunct, a hydrotrope, a dispersant, a rheology modifier, and a combination of two or more thereof.

17. The laundry detergent composition of claim 16, where the laundry detergent composition is a liquid laundry detergent composition.

18. A foam control formulation comprising:
A) the copolymer of claim 4;
0.5 to 50 wt %, based on weight of A) the copolymer, of B) a hydrophobic filler,
1 to 50 wt %, based on weight of A) the copolymer, of C) a silicone resin,
0 to 60 wt %, based on weight of C) the silicone resin, of D) an organic solvent in which the resin is soluble.
